(19) United States
(12) Patent Application Publication
(10) Pub. No.: US 2025/0043495 A1
(43) Pub. Date: Feb. 6, 2025

(54) CLOTHING TREATMENT EQUIPMENT, CLOTHING TREATMENT METHOD, AND ATOMIZATION DEVICE

(71) Applicants: QINGDAO HAIER LAUNDRY ELECTRIC APPLIANCES CO., LTD, Qingdao, Shandong (CN); Haier Smart Home Co., Ltd., Qingdao, Shandong (CN)

(72) Inventors: Hanwu YU, Qingdao (CN); Yonghong XU, Qingdao (CN); Lijun ZHANG, Qingdao (CN); Xueli ZHAO, Qingdao (CN)

(73) Assignees: QINGDAO HAIER LAUNDRY ELECTRIC APPLIANCES CO., LTD, Qingdao, Shandong (CN); Haier Smart Home Co., Ltd., Qingdao, Shandong (CN)

(21) Appl. No.: 18/719,566

(22) PCT Filed: Nov. 8, 2022
(86) PCT No.: PCT/CN2022/130490

§ 371 Date: Jun. 13, 2024

(30) Foreign Application Priority Data
Dec. 13, 2021 (CN) 202111523021.8
Dec. 13, 2021 (CN) 202111523022.2
Dec. 13, 2021 (CN) 202111523025.6
Dec. 13, 2021 (CN) 202111523029.4
Dec. 13, 2021 (CN) 202111523041.5
Dec. 13, 2021 (CN) 202111542406.9

(51) Int. Cl. D06F 39/02; B05B 7/16; D06F 25/00; D06F 34/10; D06F 37/02; D06F 37/26; D06F 39/08; D06F 39/14; D06F 58/20

(52) U.S. Cl. CPC D06F 39/02; B05B 7/16; D06F 25/00; D06F 34/10; D06F 37/02; D06F 37/266; D06F 39/088; D06F 39/14; D06F 58/203

(57) ABSTRACT

Clothing treatment equipment including a housing, a clothing treatment drum, and a door device; the clothing treatment drum is arranged in the housing; a clothing putting opening is formed on the housing; the door device is used for opening and closing the clothing putting opening; the clothing putting opening is connected to the clothing treatment drum by means of a connecting member; the clothing treatment equipment further comprises an atomization device containing a clothing treatment agent; the atomization device is provided on the clothing treatment drum, the door device, and/or the connecting member; the atomization device is provided with at least one outlet facing the interior of the clothing treatment drum, so that the atomization device sprays atomized gas into the clothing treatment drum. The atomization structure can be simplified to avoid occupying too much space, and the application range of the atomization structure is also widened.

### FIELD

The present disclosure relates to the technical field of clothing treatment, and specifically provides a clothing treatment apparatus, a clothing treatment method, and an atomization device.

### BACKGROUND

A clothing treatment apparatus is an apparatus capable of washing, rinsing, spin-drying and/or drying the clothing. Common clothing treatment apparatuses include washing machines, clothing dryers, washing-drying integrated machines, and clothing care machines, etc.

With the continuous improvement of living standards, user's demands on the clothing treatment apparatus not only lie in clothing washing and drying, but also may lie in wrinkle removal, deodorization, disinfection, sterilization, bleaching, softening or fragrance enhancement of clothing. For example, atomization washing can wet the clothing in advance, which is advantageous for the penetration of clothing treatment agents into the clothing.

In the prior art, atomization washing is generally achieved through an atomizer, which is fused with a water inflow system to use water inflow of the water inflow system to achieve water supply to the atomizer; then, under the action of the atomizer, the water is transformed into atomized droplets of small particles, which enter a clothing treatment cylinder to achieve atomization washing of clothing. However, due to the existence of pipelines, fusing the atomizer and the water inflow system together is not advantageous for the arrangement of elements and components, and clothing treatment agents also need to be dispensed through separate dispensers, which take up a lot of space. Moreover, in some clothing dryers, adding too many elements and components to achieve atomization washing is also not advantageous for spatial layout. The traditional structure for achieving atomization washing has affected its application range.

In view of this, there is a need for a new clothing treatment apparatus and a clothing treatment method thereof in the art to solve the above problems.

### SUMMARY

The present disclosure aims to solve the above technical problems, that is, to solve the problems that the structure of existing clothing treatment apparatuses for achieving atomization washing is too complex and has a small application range.

In a first aspect, the present disclosure provides a clothing treatment apparatus, which includes a cabinet, a clothing treatment cylinder, and a door device; the clothing treatment cylinder is arranged in the cabinet, and a clothing throw-in port is formed on the cabinet; the door device is configured to open and close the clothing throw-in port, and the clothing throw-in port is connected with the clothing treatment cylinder through a connecting member; and

the clothing treatment apparatus further includes an atomization device accommodating a clothing treatment agent; the atomization device is arranged on the clothing treatment cylinder, the door device and/or the connecting member, and the atomization device has at least one outlet arranged toward an interior of the clothing treatment cylinder so that the atomization device can spray atomized gas into the clothing treatment cylinder.

### BRIEF DESCRIPTION OF DRAWINGS

Preferred embodiments of the present disclosure will be described below in connection with the accompanying drawings, in which:

FIG. 1 is a first schematic view of an overall structure of the atomization device in a first embodiment of the present disclosure;

FIG. 2 is a second schematic view of the overall structure of the atomization device in the first embodiment of the present disclosure;

FIG. 3 is a first exploded view of the atomization device in the first embodiment of the present disclosure (with arrows indicating an installation process of the atomization device);

FIG. 4 is a second exploded view of the atomization device in the first embodiment of the present disclosure (with arrows indicating the installation process of the atomization device);

FIG. 5 is a schematic structural view of a box body of a water box of the atomization device in the first embodiment of the present disclosure;

FIG. 6 is a schematic structural view of a second sealing member of the atomization device in the first embodiment of the present disclosure;

FIG. 7 is a schematic structural view of a box cover of the water box of the atomization device in the first embodiment of the present disclosure;

FIG. 8 is a first schematic view of an overall structure of the atomization device in a second embodiment of the present disclosure;

FIG. 9 is a second schematic view of the overall structure of the atomization device in the second embodiment of the present disclosure;

FIG. 10 is an exploded view of the atomization device in the second embodiment of the present disclosure (with arrows indicating the installation process of the atomization device);

FIG. 11 is a schematic structural view of a box body of the atomization device in the second embodiment of the present disclosure;

FIG. 12 is a schematic structural view of a sealing member of the atomization device in the second embodiment of the present disclosure;

FIG. 13 is a schematic structural view of a box cover of the atomization device in the second embodiment of the present disclosure;

FIG. 14 is a first schematic view of an overall structure of the atomization device in a third embodiment of the present disclosure;

FIG. 15 is a second schematic view of the overall structure of the atomization device in the third embodiment of the present disclosure;

FIG. 16 is a first exploded view of the atomization device in the third embodiment of the present disclosure (with arrows indicating the installation process of the atomization device);

FIG. 17 is a second exploded view of the atomization device in the third embodiment of the present disclosure (with arrows indicating the installation process of the atomization device);

FIG. 18 is a schematic structural view of a box body of a water box of the atomization device in the third embodiment of the present disclosure;

FIG. 19 is a schematic structural view of a sealing member of the atomization device in the third embodiment of the present disclosure;

FIG. 20 is a schematic structural view of a box cover of the water box of the atomization device in the third embodiment of the present disclosure;

FIG. 21 is a first schematic view of an overall structure of the atomization device in a fourth embodiment of the present disclosure;

FIG. 22 is a second schematic view of the overall structure of the atomization device in the fourth embodiment of the present disclosure;

FIG. 23 is a first exploded view of the atomization device in the fourth embodiment of the present disclosure (with arrows indicating the installation process of the atomization device);

FIG. 24 is a second exploded view of the atomization device in the fourth embodiment of the present disclosure (with arrows indicating the installation process of the atomization device);

FIG. 25 is a schematic structural view of a box body of a water box of the atomization device in the fourth embodiment of the present disclosure;

FIG. 26 is a schematic structural view of a sealing member of the atomization device in the fourth embodiment of the present disclosure;

FIG. 27 is a schematic structural view of a box cover of the water box of the atomization device in the fourth embodiment of the present disclosure;

FIG. 28 is a first schematic view of an overall structure of the atomization device in a fifth embodiment of the present disclosure;

FIG. 29 is a second schematic view of the overall structure of the atomization device in the fifth embodiment of the present disclosure;

FIG. 30 is a first exploded view of the atomization device in the fifth embodiment of the present disclosure (with arrows indicating the installation process of the atomization device);

FIG. 31 is a second exploded view of the atomization device in the fifth embodiment of the present disclosure (with arrows indicating the installation process of the atomization device);

FIG. 32 is a schematic structural view of a box body of a water box of the atomization device in the fifth embodiment of the present disclosure;

FIG. 33 is a schematic structural view of a sealing member of the atomization device in the fifth embodiment of the present disclosure;

FIG. 34 is a schematic structural view of a box cover of the water box of the atomization device in the fifth embodiment of the present disclosure;

FIG. 35 is a first schematic view of an overall structure of the atomization device in a sixth embodiment of the present disclosure;

FIG. 36 is a second schematic view of the overall structure of the atomization device in the sixth embodiment of the present disclosure;

FIG. 37 is an exploded view of the atomization device in the sixth embodiment of the present disclosure (with arrows indicating the installation process of the atomization device);

FIG. 38 is a schematic structural view of a box body of a water box of the atomization device in the sixth embodiment of the present disclosure;

FIG. 39 is a schematic structural view of a second sealing member of the atomization device in the sixth embodiment of the present disclosure; and

FIG. 40 is a schematic structural view of a box cover of the water box of the atomization device in the sixth embodiment of the present disclosure.

### DETAILED DESCRIPTION

Preferred embodiments of the present disclosure will be described below with reference to the accompanying drawings. It should be understood by those skilled in the art that these embodiments are only used to explain the technical principle of the present disclosure, and are not intended to limit the scope of protection of the present disclosure. For example, the clothing treatment apparatus of the present disclosure can be a washing-drying integrated machine, or a clothing dryer, or a clothing care machine, etc. Such adjustments to the application object do not constitute limitations to the present disclosure.

It should be noted that in the description of the present disclosure, terms indicating directional or positional relationships, such as “upper”, “lower”, “inner”, “outer” and the like, are based on the directional or positional relationships shown in the accompanying drawings. They are only used for ease of description, and do not indicate or imply that the device or component must have a specific orientation, or must be constructed or operated in a specific orientation; therefore, they should not be considered as limitations to the present disclosure. In addition, it should also be noted that terms “first”, “second” and “third” are only used for descriptive purpose, and should not be understood as indicating or implying relative importance.

In addition, it should also be noted that in the description of the present disclosure, unless otherwise clearly specified and defined, terms “arrange”, “connect” and “connection” should be understood in a broad sense; for example, the “connection” may be a detachable connection, or an integral connection; it may be a direct connection, or an indirect connection implemented through an intermediate component. For those skilled in the art, the specific meaning of the above terms in the present disclosure can be interpreted according to specific situations.

### First Embodiment

In view of the problems pointed out in the “BACKGROUND” that the structures of existing clothing treatment apparatuses for achieving atomization washing are too complex and have a small application range, the present disclosure provides a clothing treatment apparatus and a clothing treatment method thereof, aiming to simplify the atomization structure, avoid occupying too much space, and also improve the application range of the atomization structure.

Specifically, the clothing treatment apparatus of the present disclosure includes a cabinet, a clothing treatment cylinder, and a door device; the clothing treatment cylinder is arranged in the cabinet, and a clothing throw-in port is formed on the cabinet; the door device is configured to open and close the clothing throw-in port, and the clothing throw-in port is connected with the clothing treatment cylinder through a connecting member; the clothing treatment apparatus further includes an atomization device accommodating a clothing treatment agent; the atomization device is arranged on the clothing treatment cylinder, the door device and/or the connecting member, and the atomization device has at least one outlet arranged toward an interior of the clothing treatment cylinder so that the atomization device can spray atomized gas into the clothing treatment cylinder. When the clothing treatment apparatus is a clothing dryer, the clothing treatment cylinder is a drying cylinder. When the drying cylinder is a single cylinder structure, the atomization device is preferably arranged on the drying cylinder, the door device and/or the connecting member. At this time, the connecting member is a front support structure of the clothing dryer. A front end of the front support structure is connected with the clothing throw-in port of the cabinet, and a rear end of the front support structure is connected with a front end of the drying cylinder through a dynamic sealing structure. The front support structure not only supports the front end of the drying cylinder, but also does not affect the rotation of the drying cylinder. When the clothing treatment apparatus is a washing-drying integrated machine, the clothing treatment cylinder is a washing and drying cylinder, and the clothing treatment cylinder is a sleeve structure, that is, the clothing treatment cylinder has an outer cylinder and an inner cylinder (also known as a drum) rotatably arranged in the outer cylinder. The atomization device can be arranged on the outer cylinder, the door device and/or the connecting member. At this time, the connecting member is the window gasket. A front end of the window gasket is connected with the clothing throw-in port, and a rear end of the window gasket is connected with the outer cylinder. The window gasket is used to ensure scaling between the outer cylinder and the clothing throw-in port. In the present disclosure, the atomization device can be an ultrasonic atomizer with a clothing treatment agent accommodating chamber, or an atomization nozzle with a clothing treatment agent accommodating chamber, or another atomization structure, as long as the atomized gas can be sprayed into the clothing treatment cylinder through the atomization device. In addition, the clothing treatment agent can be water, or detergent, softener, softening agent, fragrance enhancer, or another clothing treatment solvent, or a mixture of the aforementioned water and solvents. The atomized gas is droplets with a large number of small particles formed. Since it is not easy to observe each small droplet with the naked eye, a gas like structure is formed. The atomization device can disperse the clothing treatment agent and dispense it onto the clothing in the clothing treatment cylinder.

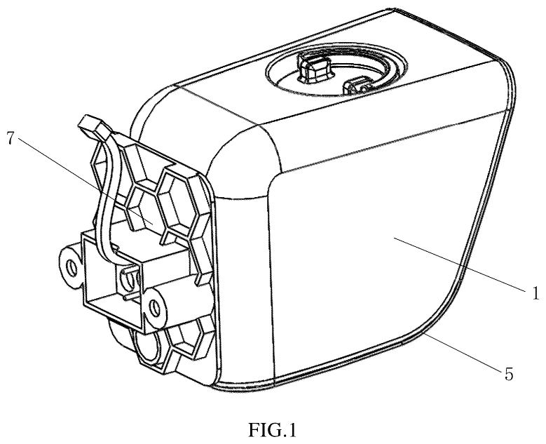

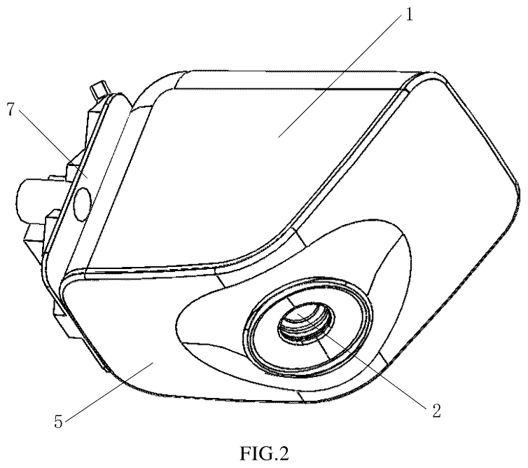

In a possible case, as shown in FIGS. 1 to 4, the atomization device includes a water box 1 and an atomization sheet 2. The water box 1 is arranged on the clothing treatment cylinder, the door device and/or the connecting member. An outlet la is formed on the water box 1, and a water containing chamber 1b is formed in the water box 1 to accommodate the clothing treatment agent. The number of outlet 1a is one, and the outlet 1a is communicated with the water containing chamber 1b. The atomization sheet 2 is arranged on the outlet 1a. That is, the number of water containing chamber 1b can be one and it is communicated with one outlet 1a. The structure of a single atomization port can minimize the size of the atomization device and avoid occupying a relatively large space. When there is one water containing chamber 1b, water and water-soluble clothing treatment agents can be mixed to form a mixed liquid, which is then placed in the water containing chamber 1b. The vibration of the atomization sheet 2 disperses the mixed liquid and dispenses it onto the clothing in the clothing treatment cylinder. In another possible case, the atomization device includes a water box 1 and a plurality of atomization sheets 2. The water box 1 is arranged on the clothing treatment cylinder, the door device and/or the connecting member, and a plurality of water containing chambers 1b are formed in the water box 1 to accommodate the same or different clothing treatment agents. The number of outlet 1a is multiple and all the outlets 1a are formed on the water box 1. The water containing chambers 1b, the outlets 1a, and the atomization sheets 2 correspond to each other in a one-to-one correspondence. The outlets 1a are communicated with the corresponding water containing chambers 1b, and the atomization sheets 2 are arranged on the corresponding outlets 1a. That is, in addition to using the structure of single atomization port mentioned above, a structure of multiple atomization ports can also be used. Through such an arrangement, users can flexibly add different or the same clothing treatment agents to the plurality of water containing chambers 1b according to their own needs, thereby achieving diversified care of clothing, enabling personalized customization of clothing care for users, achieving personalized clothing care experience, and meeting various needs of users.

The atomization sheet 2 is preferably an ultrasonic atomization sheet. Of course, it can also be other atomization sheets, as long as the atomization sheet 2 can disperse the clothing treatment agent.

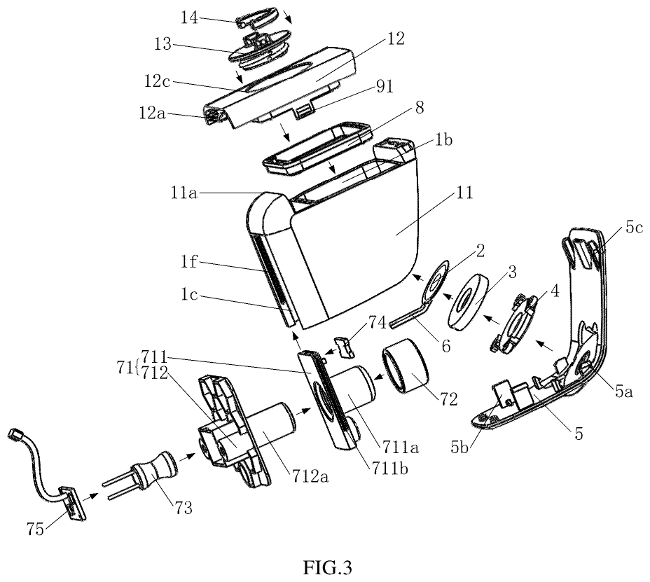

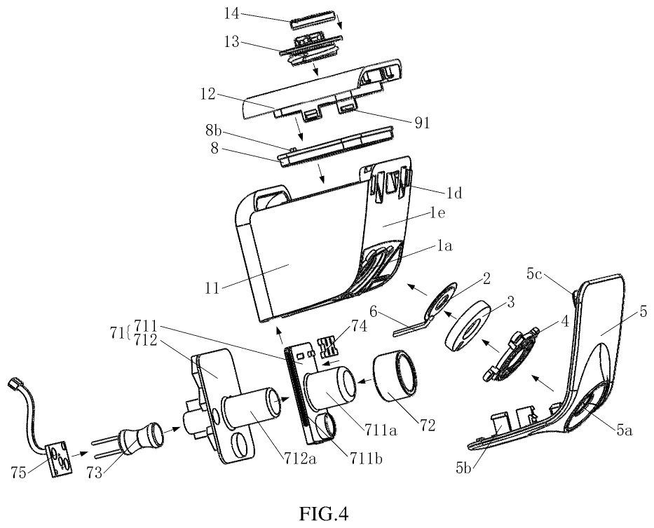

Preferably, as shown in FIGS. 3 and 4, a first sealing member 3 and a scaling pressure ring 4 are arranged on the outlet 1a; the atomization sheet 2 is accommodated in the first sealing member 3, and the sealing pressure ring 4 is pressed against a side of the first sealing member 3 that is close to the interior of the clothing treatment cylinder. The first sealing member 3 can be a sealing ring, or a sealing gasket, or other sealing structures, as long as the first sealing member 3 can accommodate the atomization sheet 2 and does not affect the spraying of atomized gas into the interior of the clothing treatment cylinder by the atomization sheet 2. The sealing pressure ring 4 can compress the first sealing member 3, thereby making the engagement between the first sealing member 3 and the outlet 1a tighter, and improving the sealing effect. An inner ring opening formed by the sealing pressure ring 4 ensures the internal communication between the atomization sheet 2 and the clothing treatment cylinder. Specifically, the sealing pressure ring 4 can be connected with the water box 1 through screw fittings such as bolts or screws.

Preferably, as shown in FIGS. 1 to 4, a side of the water box 1 that faces the interior of the clothing treatment cylinder is snap-fitted with a decorative shell 5, and an opening 5a communicated with the outlet 1a is formed on the decorative shell 5. The opening 5a ensures that the atomization sheet 2 sprays atomized gas into the interior of the clothing treatment cylinder. A plurality of claws 5b can be arranged on the decorative shell 5, and a plurality of snap-fit protrusions can be arranged on the water box 1. The claws 5b are snap-fitted with the snap-fit protrusions in a one-to-one correspondence to achieve the connection between the decorative shell 5 and the water box 1. Positioning ribs 5c can also be arranged on the decorative shell 5, and positioning grooves Id can be arranged on the water box 1. The positioning ribs 5c are mated with the positioning grooves 1d for positioning. During installation, first, the positioning ribs 5c on the decorative shell 5 are aligned with the positioning grooves 1d on the water box 1. Then, as the positioning ribs 5c gradually go deeper into the positioning grooves 1d, the corresponding claws 5b and snap-fit protrusions are snap-fitted with each other, thus achieving pre-positioning through the positioning grooves 1d and the positioning ribs 5c. Then, the claws 5b and the snap-fit protrusions achieve accurate snap-fit between the decorative shell 5 and the water box 1. Of course, in practical applications, other snap-fit methods can also be used to achieve mutual snap-fit between the decorative shell 5 and the water box 1.

Preferably, as shown in FIGS. 3 to 5, the water box 1 is also formed with an electrical chamber 1c; the electrical chamber 1e is isolated from the water containing chamber 1b, and the electrical chamber 1c can accommodate a wire harness 6 connected with the atomization sheet 2. Specifically, the electrical chamber 1c and the water containing chamber 1b can be separated by a partition structure 1e, which ensures the closure of the water containing chamber 1b. The outlet 1a is formed on the partition structure 1e, and the electrical chamber 1c can be closed or non-closed. In the structure shown in FIG. 4, a lower part of the electrical chamber 1c is closed by the decorative shell 5, and the electrical chamber 1c can accommodate the wire harness 6 connected with the atomization sheet 2, thereby achieving power supply and control of the atomization sheet 2. More preferably, an accommodation groove is formed on an outer side of the partition structure 1e, and the wire harness 6 can be partially accommodated in the accommodation groove, thereby positioning the wire harness 6.

Preferably, as shown in FIGS. 3 and 4, the atomization device further includes a wireless charging assembly 7 for supplying power to the atomization sheet 2; the wireless charging assembly 7 is connected with the water box 1, and a part of the wireless charging assembly 7 is located inside the electrical chamber 1c. The wireless charging assembly 7 can adopt electromagnetic induction wireless charging method, or magnetic resonance wireless charging method; of course, other wireless charging methods can also be used. In a preferred case, the wireless charging assembly 7 includes a fixed member 71, an induction coil 72, an inductive element 73, a first circuit board 74, and a second circuit board 75; the fixed member 71 is arranged on the clothing treatment cylinder, the door device and/or the connecting member, and the fixed member 71 is connected with the water box 1; the induction coil 72 and the inductive element 73 are both arranged on the fixed member 71, and the induction coil 72 is sleeved on an outer side of the inductive element 73; the first circuit board 74 is connected with the induction coil 72, and the second circuit board 75 is connected with the inductive element 73. The fixed member 71 can be a fixed bracket, or a fixed plate, or another fixed structure. The induction coil 72 is connected to the atomization sheet 2 through the wire harness 6, or the first circuit board 74 is connected to the atomization sheet 2 through the wire harness 6. The second circuit board 75 is connected to a power source through a wire harness. The inductive element 73 generates a certain current in the induction coil 72 through electromagnetic induction based on a certain frequency of AC electricity, thereby transferring electrical energy from the inductive element 73 to the induction coil 72, and achieving power supply to the atomization sheet 2. By using this wireless charging method, the arrangement of wire harness between the inductive element 73 and the induction coil 72 is omitted. Of course, as an alternative, wired connection can also be used to provide power to the atomization sheet 2.

Preferably, as shown in FIGS. 3 and 4, the fixed member 71 includes a fixed inner plate 711 and a fixed outer plate 712; the fixed inner plate 711 is connected with the water box 1, and the fixed outer plate 712 is fixed on the clothing treatment cylinder, the door device and/or the connecting member; the fixed outer plate 712 is formed with a first hollow columnar structure 712a, and the fixed inner plate 711 is formed with a second hollow columnar structure 711a; the second hollow columnar structure 711a is sleeved on the first hollow columnar structure 712a, the induction coil 72 is sleeved on the second hollow columnar structure 711a, and the inductive element 73 is arranged in the first hollow columnar structure 712a; the first circuit board 74 is arranged on the fixed inner plate 711, and the second circuit board 75 is arranged on the fixed outer plate 712. The first hollow columnar structure 712a is formed on a side of the fixed outer plate 712 that is close to the fixed inner plate 711, i.e., the side facing the interior of the clothing treatment cylinder. The second hollow columnar structure 711a is formed on a side of the fixed inner plate 711 that is away from the fixed outer plate 712, i.e., also the side facing the interior of the clothing treatment cylinder. A diameter of outer tube wall of the first hollow columnar structure 712a is preferably equal to a diameter of inner tube wall of the second hollow columnar structure 711a, so that the first hollow columnar structure 712a and the second hollow columnar structure 711a can be positioned with each other. The first hollow columnar structure 712a and the second hollow columnar structure 711a are made of insulative materials such as glass, plastic, or ceramics. Not using metals can avoid electromagnetic shielding. It should be noted that an inner end of the first hollow columnar structure 712a and an inner end of the second hollow columnar structure 711a (i.e., ends close to the clothing treatment cylinder) are preferably both closed to prevent external dirt from entering the electrical chamber 1c. Through such an arrangement, the fixed outer plate 712 can serve as an installation base for the fixed inner plate 711. The fixed outer plate 712 can be fixed on the clothing treatment cylinder, the door device and/or the connecting member. When it is necessary to add the clothing treatment agent into the water box 1 or replace the clothing treatment agent, the fixed inner plate 711 can be detached from the fixed outer plate 712. Then during installation, the fixed inner plate 711 can be installed on the fixed outer plate 712. The first hollow columnar structure 712a and the second hollow columnar structure 711a can play a role of positioning during installation. At the same time, the first hollow columnar structure 712a can accommodate the inductive element 73, and the induction coil 72 can be sleeved outside the second hollow columnar structure 711a, so that both the first hollow columnar structure 712a and the second hollow columnar structure 711a have multiple functions, thereby further improving the compactness of the atomization device. In addition, a magnetic adsorption structure can be arranged between the fixed inner plate 711 and the fixed outer plate 712. For example, a first permanent magnet is arranged on the fixed outer plate 712, and a second permanent magnet is arranged on the fixed inner plate 711. The magnetic properties of the first permanent magnet and the second permanent magnet are opposite, thereby achieving magnetic adsorption fixation of the fixed inner plate 711 by the fixed outer plate 712. The fixed outer plate 712 can be fixed on the clothing treatment cylinder, the door device and/or the connecting member through screw connection.

Preferably, an installation port is formed on the water box 1, an installation rib is formed on an inner wall of the installation port, and an installation groove is formed at an edge of the fixed inner plate 711; the installation rib is arranged in the installation groove to fix the fixed inner plate 711 on the water box 1. The installation port can be a square port or a semi-circular port, as long as it can allow the fixed inner plate 711 to enter the installation port. For example, in the structures shown in FIGS. 3 and 4, the installation port is a square port, a U-shaped installation rib 1_{f} is formed on the inner wall of the square port, and the edge of the fixed inner plate 711 is formed with a U-shaped installation groove 711b. The fixed inner plate 711 is inserted into the installation port from one side of the installation port, and two sides of the U-shaped installation rib 1f are first engaged with two sides of the U-shaped installation groove 711b through insertion. When inserted in place, all three sides of the U-shaped installation rib 1f are engaged with three sides of the U-shaped installation groove 711b through insertion. When the decorative shell 5 is provided, the decorative shell 5 can abut against the bottom of the fixed inner plate 711. That is, during installation, the fixed inner plate 711 is first installed on the water box 1, and then the decorative shell 5 is snap-fitted on the water box 1. The decorative shell 5 can not only bear the bottom of the fixed inner plate 711, but also can seal the electrical chamber 1c.

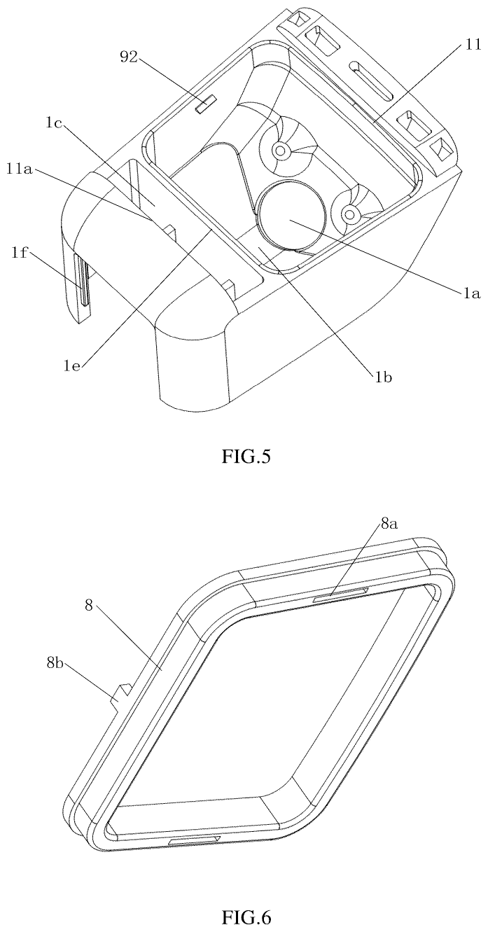

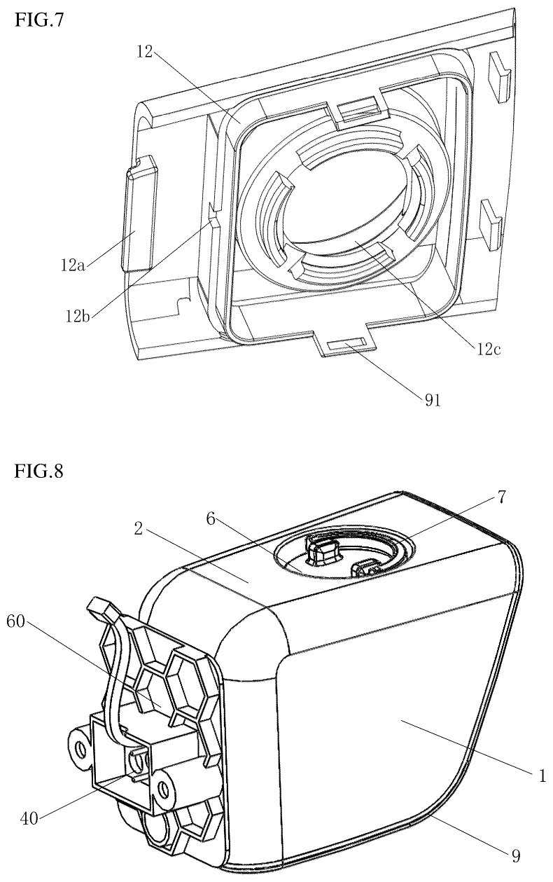

In the present disclosure, the water box 1 can have an integrated structure or a split structure. The split structure can facilitate the cleaning of the interior of the water box 1. For example, as shown in FIGS. 3 to 7, the water box 1 includes a box body 11 and a box cover 12; the box body 11 is arranged on the clothing treatment cylinder, the door device and/or the connecting member, and the outlet 1a is formed on the box body 11; an abutment member and a snap-fit member are arranged between the box cover 12 and the box body 11; and when the box cover 12 and the box body 11 are installed, the box cover 12 is first abutted onto the box body 11 through the abutment member, and then the box cover 12 and the box body 11 are snap-fitted and fixed through the snap-fit member. The abutment member can be an abutment rib, or a structure in which an abutment rib matches with an abutment groove. For example, an abutment rib can be formed on the box cover 12. An L-shaped abutment rib 12a is shown in FIGS. 3 and 7. During installation, the L-shaped abutment rib 12a can be abutted against an edge of a box opening 11a formed on the box body 11 and matched with the box cover 12. Then, the box cover 12 can be snap-fitted with the box body 11 through the snap-fit member so that the box cover 12 can cover and close the box opening 11a. Preferably, a second sealing member 8 is arranged between the box body 11 and the box cover 12, and a through opening 8a is formed on the second sealing member 8; the snap-fit member includes a first snap-fit element 91 arranged on the box cover 12 and a second snap-fit element 92 arranged on the box body 11, and the first snap-fit element 91 passes through the through opening 8a and is snap-fitted and fixed with the second snap-fit element 92. The second sealing member 8 can be a sealing ring, or a scaling gasket, or other scaling structures. Through the cooperation of the through opening 8a and the first snap-fit element 91, the first snap-fit element 91 can not only be snap-fitted with the second snap-fit element 92 to achieve the installation of the box cover 12 and the box body 11, but also can position the second scaling member 8 to prevent the second sealing member 8 from moving when the box cover 12 covers and closes the box opening 11a. Of course, a positioning protrusion 8b can also be formed on the second sealing member 8, and a positioning groove 12b can be formed on the box cover 12. The positioning protrusion 8b is mated with the positioning groove 12b. Taking the second scaling member 8 being a square ring-shaped sealing gasket as an example, there can be two first snap-fit elements 91, which are located on a pair of sides of the square ring-shaped sealing gasket; there are two positioning protrusions 8b, which are located on the other pair of sides of the square ring-shaped sealing gasket; and correspondingly, there are two positioning grooves 12b. When the box cover 12 covers and closes the box opening 11a, the mating between the first snap-fit elements 91 and the through opening 8a can achieve the positioning of one pair of sides of the square ring-shaped sealing gasket, and the mating between the positioning protrusions 8b and the positioning grooves 12b can achieve the positioning of the other pair of sides of the square ring-shaped scaling gasket, ensuring that all four sides of the square ring-shaped sealing gasket can be positioned and that the square ring-shaped sealing gasket will not move or deform. Alternatively, in the above, the number of the positioning protrusion 8b and the number of the positioning groove 12b can both be one. In a preferred case, the first snap-fit element 91 is a snap-fit plate with a snap-fit opening, and the second snap-fit element 92 is a snap-fit protrusion. During installation, the snap-fit plate passes through the through opening 8a and exposes the snap-fit opening so that the snap-fit opening is snap-fitted with the snap-fit protrusion. Of course, the first snap-fit element 91 and the second snap-fit element 92 can also use other snap-fit methods.

Preferably, as shown in FIGS. 3, 4 and 7, the water box 1 further includes a feeding cover 13, and a feeding port 12c is formed on the box cover 12; a first spiral groove is formed on the feeding cover 13, a second spiral groove is formed on the feeding port 12c, and the feeding cover 13 is screw-connected with the feeding port 12c through the first spiral groove and the second spiral groove. Specifically, the screw connection between the feeding cover 13 and the feeding port 12c enables the feeding cover 13 to screw in and out relative to the feeding port 12c. That is, rotating the feeding cover 13 in one direction enables the feeding cover 13 to screw in and close the feeding port 12c, and rotating the feeding cover 13 in the other direction enables the feeding cover 13 to screw out and open the feeding port 12c. Of course, the feeding cover 13 and the feeding port 12c can also adopt a flip over structure with a pivotal connection. A third scaling member can be arranged between the feeding cover 13 and the feeding port 12c, and the third sealing member can be a sealing ring, or a sealing gasket, or other sealing structures.

Preferably, as shown in FIGS. 3 and 4, a handle ring 14 is rotatably connected with an outer surface of the feeding cover 13, and the handle ring 14 can rotate in a non-pulling state and be accommodated in the feeding port 12c. The handle ring 14 can be connected to the outer surface of the feeding cover 13 through pivotal connection. After the feeding port 12c is closed by the feeding cover 13, the outer surface of the feeding cover 13 has a certain distance from an outer edge of the feeding port 12c. This distance ensures that the handle ring 14 in the non-pulling state can be accommodated. In this state, the plane where the handle ring 14 is located is parallel to the plane where the outer surface of the feeding cover 13 is located. When the handle ring 14 is in a pulling state (for example, the handle ring 14 exposes the feeding port 12c, making it easier for the user to grip), the plane where the handle ring 14 is located is perpendicular to or at a certain angle to the plane where the outer surface of the feeding cover 13 is located, so that twisting the handle ring 14 enables the feeding cover 13 to screw out of the feeding port 12c.

The clothing treatment method of the clothing treatment apparatus of the present disclosure includes: spraying atomized gas onto the clothing in the clothing treatment cylinder. In practical applications, it is also possible to detect the material and/or type of the clothing in the clothing treatment cylinder, and determine the amount of atomized gas dispensed by the atomization device based on the material and/or type of the clothing. The dispensing timing and dispensing duration can also be determined based on the material and/or type of the clothing.

### Second Embodiment

In view of the problems that existing atomization devices have limited application scenes and the interior thereof cannot be cleaned, the present disclosure provides an atomization device and a clothing treatment apparatus, aiming to enrich the application scenes of atomization devices, avoid scaling and blockage in the atomization devices, and prolong the service life of the atomization devices.

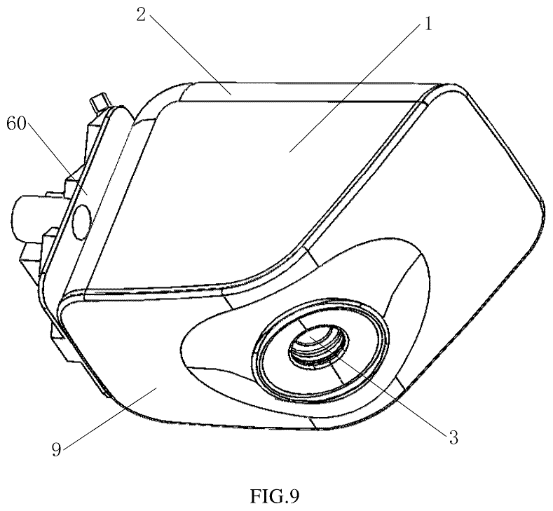

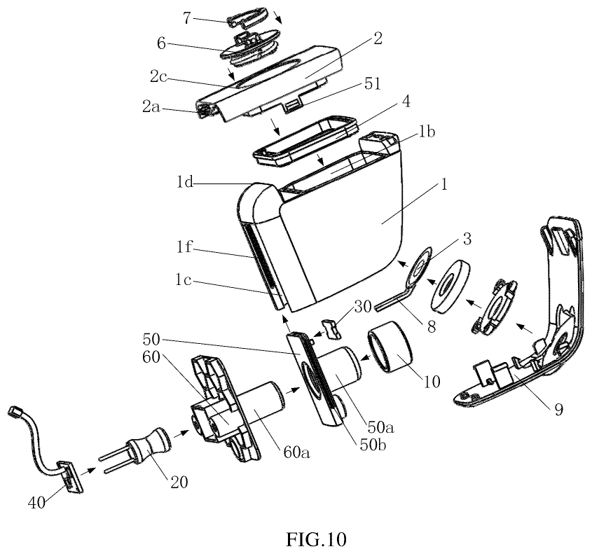

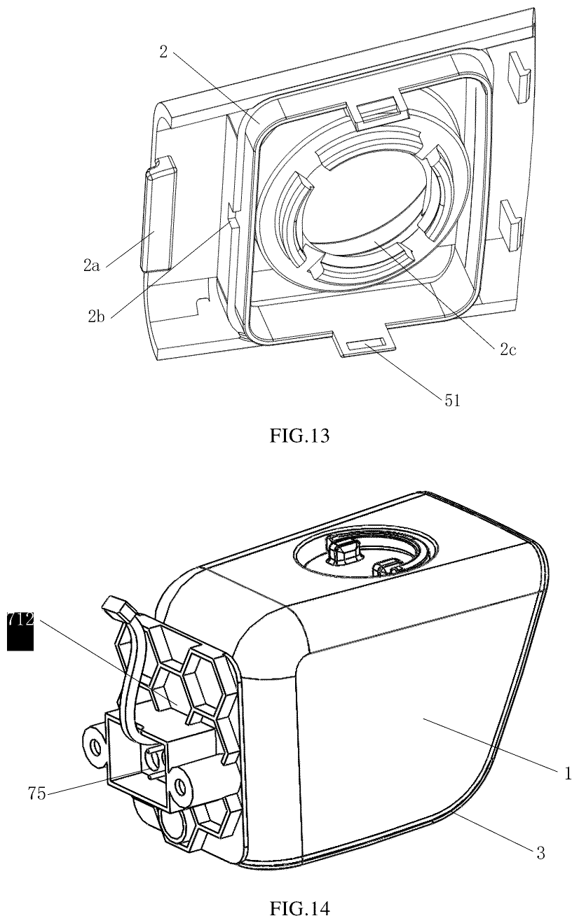

Specifically, as shown in FIGS. 8 to 10, the atomization device of the present disclosure includes a box body 1, a box cover 2 and an atomization sheet 3; an outlet 1a is formed on the box body 1, and the atomization sheet 3 is arranged at the outlet 1a; an abutment member and a snap-fit member are arranged between the box cover 2 and the box body 1; and when the box cover 2 and the box body 1 are installed, the box cover 2 is first abutted onto the box body 1 through the abutment member, and then the box cover 2 and the box body 1 are snap-fitted and fixed through the snap-fit member. The abutment member can be an abutment rib, or a structure in which an abutment rib matches with an abutment groove. For example, an abutment rib can be formed on the box cover 2. An L-shaped abutment rib 2a is shown in FIGS. 10 and 13. During installation, as shown in FIGS. 10, 11 and 13, the L-shaped abutment rib 2a can be abutted against an edge of a box opening Id formed on the box body 1 and matched with the box cover 2. Then, the box cover 2 can be snap-fitted with the box body 1 through the snap-fit member so that the box cover 2 can cover and close the box opening 1d. The snap-fit member can be in the form of a claw matching with a snap-fit opening, or in the form of a snap-fit protrusion matching with a snap-fit groove, which can be flexibly set by those skilled in the art.

Preferably, as shown in FIGS. 10 to 13, a sealing member 4 is arranged between the box body 1 and the box cover 2, and a through opening 4a is formed on the sealing member 4; the snap-fit member includes a first snap-fit element 51 arranged on the box cover 2 and a second snap-fit element 52 arranged on the box body 1, and the first snap-fit element 51 passes through the through opening 4a and is snap-fitted and fixed with the second snap-fit element 52. The scaling member 4 can be a sealing ring, or a scaling gasket, or other scaling structures. Through the cooperation of the through opening 4a and the first snap-fit element 51, the first snap-fit element 51 can not only be snap-fitted with the second snap-fit element 52 to achieve the installation of the box cover 2 and the box body 1, but also can position the sealing member 4 to prevent the sealing member 4 from moving when the box cover 2 covers and closes the box opening 1d. Of course, a positioning protrusion 4b can also be formed on the sealing member 4, and a positioning groove 2b can be formed on the box cover 2. The positioning protrusion 4b is mated with the positioning groove 2b. Taking the sealing member 4 being a square ring-shaped scaling gasket as an example, there can be two first snap-fit elements 51, which are located on a pair of sides of the square ring-shaped scaling gasket; there are two positioning protrusions 4b, which are located on the other pair of sides of the square ring-shaped sealing gasket; and correspondingly, the number of the positioning grooves 2b is also two. When the box cover 2 covers and closes the box opening 1d, the mating between the first snap-fit elements 51 and the through opening 4a can achieve the positioning of one pair of sides of the square ring-shaped scaling gasket, and the mating between the positioning protrusions 4b and the positioning grooves 2b can achieve the positioning of the other pair of sides of the square ring-shaped scaling gasket, ensuring that all four sides of the square ring-shaped scaling gasket can be positioned and that the square ring-shaped scaling gasket will not move or deform. Alternatively, in the above, the number of the positioning protrusion 4b and the number of the positioning groove 2b can both be one. In a preferred case, the first snap-fit element 51 is a snap-fit plate with a snap-fit opening, and the second snap-fit element 52 is a snap-fit protrusion. During installation, the snap-fit plate passes through the through opening 4a and exposes the snap-fit opening so that the snap-fit opening is snap-fitted with the snap-fit protrusion. Of course, the first snap-fit element 51 and the second snap-fit element 52 can also use other snap-fit methods. Of course, in the above, the snap-fit member can also directly snap-fit the box body 1 with the box cover 2 without mating with the scaling member 4.

Preferably, as shown in FIGS. 8 and 10, the atomization device further includes a feeding cover 6, and a feeding port 2c is formed on the box cover 2; a first spiral groove is formed on the feeding cover 6, a second spiral groove is formed on the feeding port 2c, and the feeding cover 6 is screw-connected with the feeding port 2c through the first spiral groove and the second spiral groove. Specifically, the screw connection between the feeding cover 6 and the feeding port 2c enables the feeding cover 6 to screw in and out relative to the feeding port 2c. That is, rotating the feeding cover 6 in one direction enables the feeding cover 6 to screw in and close the feeding port 2c, and rotating the feeding cover 6 in the other direction enables the feeding cover 6 to screw out and open the feeding port 2c. Of course, the feeding cover 6 and the feeding port 2c can also adopt a flip over structure with a pivotal connection.

Preferably, as shown in FIGS. 8 and 10, a handle ring 7 is rotatably connected with an outer surface of the feeding cover 6, and the handle ring 7 can rotate in a non-pulling state and be accommodated in the feeding port 2c. The handle ring 7 can be connected to the outer surface of the feeding cover 6 through pivotal connection. After the feeding port 2c is closed by the feeding cover 6, the outer surface of the feeding cover 6 has a certain distance from an outer edge of the feeding port 2c. This distance ensures that the handle ring 7 in the non-pulling state can be accommodated. In this state, the plane where the handle ring 7 is located is parallel to the plane where the outer surface of the feeding cover 6 is located. When the handle ring 7 is in a pulling state (for example, the handle ring 7 exposes the feeding port 2c, making it easier for the user to grip), the plane where the handle ring 7 is located is perpendicular to or at a certain angle to the plane where the outer surface of the feeding cover 6 is located, so that twisting the handle ring 7 enables the feeding cover 6 to screw out of the feeding port 2c.

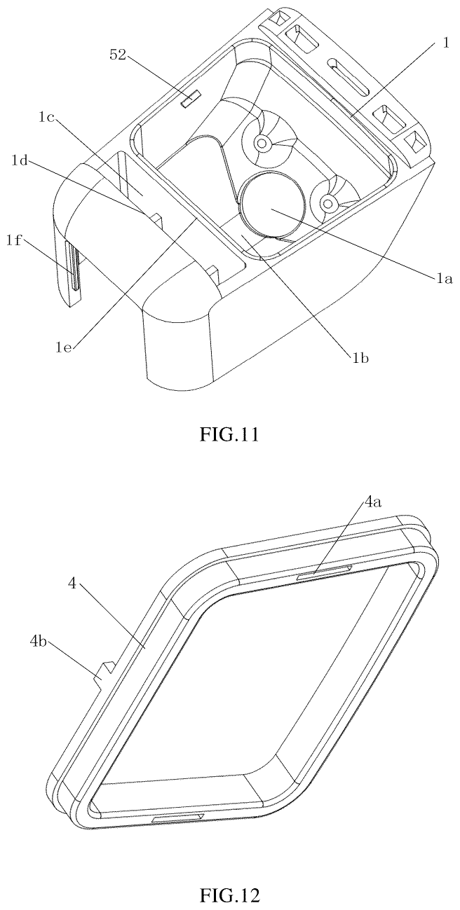

Preferably, as shown in FIGS. 10 and 11, a water containing chamber 1b and an electrical chamber 1c isolated from each other are formed inside the box body 1. The outlet 1a is communicated with the water containing chamber 1b, and the electrical chamber 1c is used to accommodate a wire harness 8 connected with the atomization sheet 3. Specifically, the electrical chamber 1c and the water containing chamber 1b can be separated by a partition structure 1e. The partition structure 1e, the box cover 2 and the feeding cover 6 ensure the closure of the water containing chamber 1b. The outlet 1a is formed on the partition structure 1e, and the electrical chamber 1c can be closed or non-closed. In the structure shown in FIG. 10, a lower part of the electrical chamber 1c is closed by a decorative shell 9, and the electrical chamber 1c can accommodate the wire harness 8 connected with the atomization sheet 3, thereby achieving power supply and control of the atomization sheet 3. More preferably, the partition structure is U-shaped, and the outlet 1a is formed at the bottom of the U-shaped partition structure. An accommodation groove is formed on an outer side of the bottom of the partition structure 1e, and the wire harness 8 can be partially accommodated in the accommodation groove, thereby positioning the wire harness 8.

Preferably, as shown in FIG. 10, the atomization device further includes a wireless charging assembly for supplying power to the atomization sheet 3; the wireless charging assembly is connected with the box body 1, and a part of the wireless charging assembly is located inside the electrical chamber 1c. The wireless charging assembly can adopt electromagnetic induction wireless charging method, or magnetic resonance wireless charging method; of course, other wireless charging methods can also be used. In a preferred case, the wireless charging assembly includes a fixed member, an induction coil 10, an inductive element 20, a first circuit board 30, and a second circuit board 40; the fixed member is arranged on other apparatuses, and the fixed member is connected with the box body 1; the induction coil 10 and the inductive element 20 are both arranged on the fixed member, and the induction coil 10 is sleeved on an outer side of the inductive element 20; the first circuit board 30 is connected with the induction coil 10, and the second circuit board 40 is connected with the inductive element 20. The fixed member can be a fixed bracket, or a fixed plate, or another fixed structure. The induction coil 10 is connected to the atomization sheet 3 through the wire harness 8, or the first circuit board 30 is connected to the atomization sheet 3 through the wire harness 8. The second circuit board 40 is connected to a power source through a wire harness. The inductive element 20 generates a certain current in the induction coil 10 through electromagnetic induction based on a certain frequency of AC electricity, thereby transferring electrical energy from the inductive element 20 to the induction coil 10, and achieving power supply to the atomization sheet 3. By using this wireless charging method, the arrangement of wire harness between the inductive element 20 and the induction coil 10 is omitted. Of course, as an alternative, wired connection can also be used to provide power to the atomization sheet 3.

Preferably, as shown in FIG. 10, the fixed member includes a fixed inner plate 50 and a fixed outer plate 60; the fixed inner plate 50 is connected with the box body 1, and the fixed outer plate 60 is fixed on other apparatuses; the fixed outer plate 60 is formed with a first hollow columnar structure 60a, and the fixed inner plate 50 is formed with a second hollow columnar structure 50a; the second hollow columnar structure 50a is sleeved on the first hollow columnar structure 60a, the induction coil 10 is sleeved on the second hollow columnar structure 50a, and the inductive element 20 is arranged in the first hollow columnar structure 60a; the first circuit board 30 is arranged on the fixed inner plate 50, and the second circuit board 40 is arranged on the fixed outer plate 60. The first hollow columnar structure 60a is formed on a side of the fixed outer plate 60 that is close to the fixed inner plate 50. The second hollow columnar structure 50a is formed on a side of the fixed inner plate 50 that is away from the fixed outer plate 60. A diameter of outer tube wall of the first hollow columnar structure 60a is preferably equal to a diameter of inner tube wall of the second hollow columnar structure 50a, so that the first hollow columnar structure 60a and the second hollow columnar structure 50a can be positioned with each other. The first hollow columnar structure 60a and the second hollow columnar structure 50a are made of insulative materials such as glass, plastic, or ceramics. Not using metals can avoid electromagnetic shielding. It should be noted that the end of the first hollow columnar structure 60a and the end of the second hollow columnar structure 50a are preferably both closed. Through such an arrangement, the fixed outer plate 60 can serve as an installation base for the fixed inner plate 50, and the fixed outer plate 60 can be fixed on other apparatuses. When it is necessary to add the solvent into the box body 1 or replace the solvent, the fixed inner plate 50 can be detached from the fixed outer plate 60. Then during installation, the fixed inner plate 50 can be installed on the fixed outer plate 60. The first hollow columnar structure 60a and the second hollow columnar structure 50a can play a role of positioning during installation. At the same time, the first hollow columnar structure 60a can accommodate the inductive element 20, and the induction coil 10 can be sleeved outside the second hollow columnar structure 50a, so that both the first hollow columnar structure 60a and the second hollow columnar structure 50a have multiple functions, thereby further improving the compactness of the atomization device. In addition, a magnetic adsorption structure can be arranged between the fixed inner plate 50 and the fixed outer plate 60. For example, a first permanent magnet is arranged on the fixed outer plate 60, and a second permanent magnet is arranged on the fixed inner plate 50. The magnetic properties of the first permanent magnet and the second permanent magnet are opposite, thereby achieving magnetic adsorption fixation of the fixed inner plate 50 by the fixed outer plate 60.

Preferably, an installation port is formed on the box body 1, an installation rib is formed on an inner wall of the installation port, and an installation groove is formed at an edge of the fixed inner plate 50; the installation rib is arranged in the installation groove to fix the fixed inner plate 50 on the box body 1. The installation port can be a square port or a semi-circular port, as long as it can allow the fixed inner plate 50 to enter the installation port. For example, in the structure shown in FIG. 10, the installation port is a square port, a U-shaped installation rib 1f is formed on the inner wall of the square port, and the edge of the fixed inner plate 50 is formed with a U-shaped installation groove 50b. The fixed inner plate 50 is inserted into the installation port from one side of the installation port, and two sides of the U-shaped installation rib 1f are first engaged with two sides of the U-shaped installation groove 50b through insertion. When inserted in place, all three sides of the U-shaped installation rib 1f are engaged with three sides of the U-shaped installation groove 50b through insertion. When the decorative shell 9 is provided, the decorative shell 9 can abut against the bottom of the fixed inner plate 50. That is, during installation, the fixed inner plate 50 is first installed on the box body 1, and then the decorative shell 9 is snap-fitted on the box body 1. The decorative shell 9 can not only bear the bottom of the fixed inner plate 50, but also can seal the electrical chamber 1c.

The clothing treatment apparatus of the present disclosure includes a cabinet, a clothing treatment cylinder, and a door device; the clothing treatment cylinder is arranged in the cabinet, and a clothing throw-in port is formed on the cabinet; the door device is configured to open and close the clothing throw-in port, and the clothing throw-in port is connected with the clothing treatment cylinder through a connecting member; the clothing treatment apparatus further includes an atomization device accommodating a clothing treatment agent; the box body 1 of the atomization device is arranged on the clothing treatment cylinder, the door device and/or the connecting member, and the atomization device has at least one outlet 1a arranged toward an interior of the clothing treatment cylinder so that the atomization device can spray atomized gas into the clothing treatment cylinder. When the clothing treatment apparatus is a clothing dryer, the clothing treatment cylinder is a drying cylinder. When the drying cylinder is a single cylinder structure, the box body 1 of the atomization device is preferably arranged on the door device and/or the connecting member. At this time, the connecting member is a front support structure of the clothing dryer. A front end of the front support structure is connected with the clothing throw-in port of the cabinet, and a rear end of the front support structure is connected with a front end of the drying cylinder through a dynamic sealing structure. The front support structure not only supports the front end of the drying cylinder, but also does not affect the rotation of the drying cylinder. When the clothing treatment apparatus is a washing-drying integrated machine, the clothing treatment cylinder is a washing and drying cylinder, and the clothing treatment cylinder is a sleeve structure, that is, the clothing treatment cylinder has an outer cylinder and an inner cylinder (also known as a drum) rotatably arranged in the outer cylinder. The box body 1 of the atomization device can be arranged on the outer cylinder, the door device and/or the connecting member. At this time, the connecting member is a window gasket. A front end of the window gasket is connected with the clothing throw-in port, and a rear end of the window gasket is connected with the outer cylinder. The window gasket is used to ensure sealing between the outer cylinder and the clothing throw-in port. In the present disclosure, the clothing treatment agent can be water, or detergent, softener, softening agent, fragrance enhancer, or another clothing treatment solvent, or a mixture of the aforementioned water and solvents. The atomized gas is droplets with a large number of small particles formed. Since it is not easy to observe each small droplet with the naked eye, a gas like structure is formed. The atomization device can disperse the clothing treatment agent and dispense it onto the clothing in the clothing treatment cylinder.

### Third Embodiment

In view of the problems that existing atomization devices have limited application scenes and have the safety hazard of being prone to short circuit, the present disclosure provides an atomization device and a clothing treatment apparatus, aiming to enrich the application scenes of atomization devices, avoid occurrence of short circuit, improve the electrical safety of atomization devices, and improve the aesthetics of atomization devices.

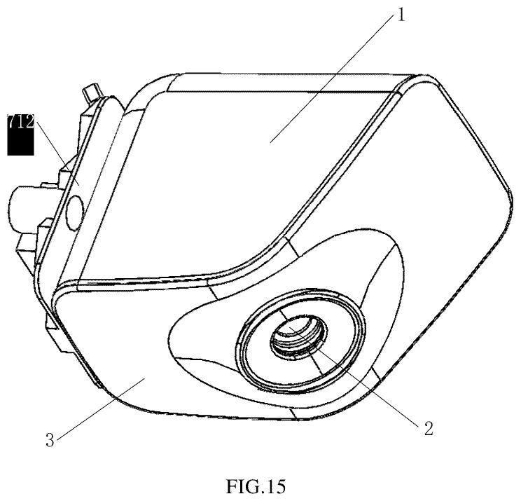

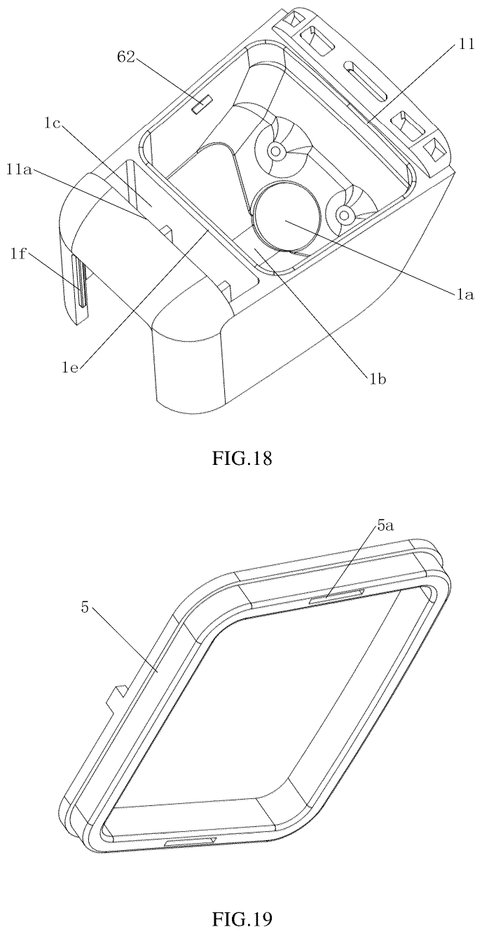

Specifically, as shown in FIGS. 14 to 20, the atomization device of the present disclosure includes a water box 1 and an atomization sheet 2; an outlet 1a is formed on the water box 1, and the atomization sheet 2 is arranged at the outlet 1a; a water containing chamber 1b and an electrical chamber 1c isolated from each other are formed inside the water box 1; the water containing chamber 1b is closed and communicated with the outlet 1a, and a decorative shell 3 is connected to the water box 1; the decorative shell 3 closes a lower part of the electrical chamber 1c, and the electrical chamber 1c is used to accommodate a wire harness 4 connected with the atomization sheet 2. An opening 3a communicated with the outlet 1a is formed on the decorative shell 3. The opening 3a ensures that the atomization sheet 2 sprays atomized gas to the outside. A plurality of elastic claws 3b can be arranged on the decorative shell 3, and a plurality of snap-fit protrusions (not shown) can be arranged on the water box 1. The elastic claws 3b are snap-fitted with the snap-fit protrusions in a one-to-one correspondence to achieve the connection between the decorative shell 3 and the water box 1. Positioning ribs 3c can also be arranged on the decorative shell 3, and positioning grooves 1d can be arranged on the water box 1. The positioning ribs 3c are mated with the positioning grooves 1d for positioning. During installation, first, the positioning ribs 3c on the decorative shell 3 are aligned with the positioning grooves 1d on the water box 1. Then, as the positioning ribs 3c gradually go deeper into the positioning grooves 1d, the corresponding elastic claws 3b and snap-fit protrusions are snap-fitted with each other, thus achieving pre-positioning through the positioning grooves 1d and the positioning ribs 3c. Then, the elastic claws 3b and the snap-fit protrusions achieve accurate snap-fit between the decorative shell 3 and the water box 1. Of course, in practical applications, other snap-fit methods can also be used to achieve mutual snap-fit between the decorative shell 3 and the water box 1.

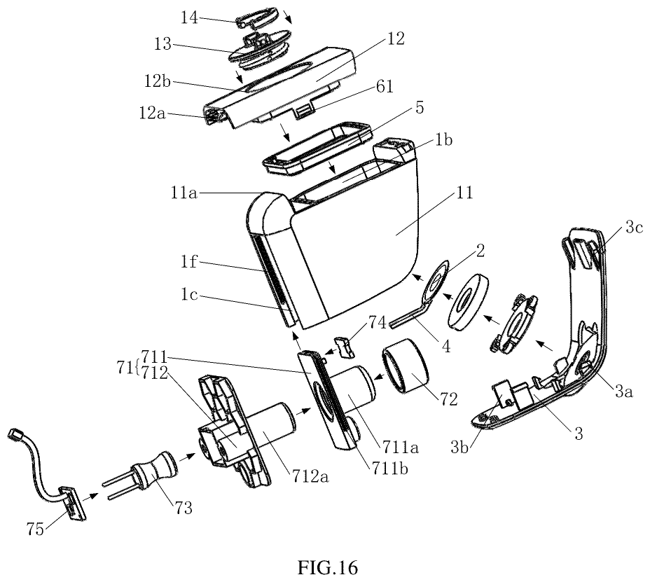

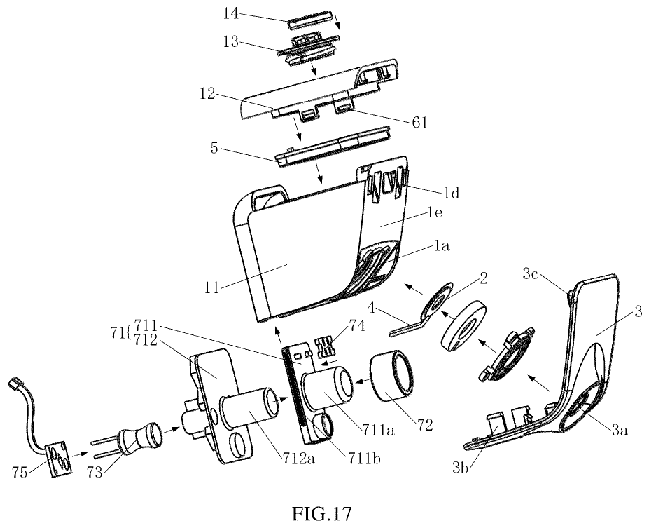

Preferably, the electrical chamber 1c is isolated from the water containing chamber 1b; the electrical chamber 1c and the water containing chamber 1b can be separated by a partition structure 1e, which ensures the closure of the water containing chamber 1b. The outlet 1a is formed on the partition structure 1e, and the electrical chamber 1c can be closed or non-closed. In the structure shown in FIGS. 16 and 17, a lower part of the electrical chamber 1c is closed by the decorative shell 3, and the electrical chamber 1c can accommodate the wire harness 4 connected with the atomization sheet 2, thereby achieving power supply and control of the atomization sheet 2. More preferably, an accommodation groove is formed on an outer side of the partition structure 1e, and the wire harness 4 can be partially accommodated in the accommodation groove, thereby positioning the wire harness 4.

Preferably, the atomization device further includes a wireless charging assembly for supplying power to the atomization sheet 2; the wireless charging assembly is connected with the water box 1, and a part of the wireless charging assembly is located inside the electrical chamber 1c. The wireless charging assembly can adopt electromagnetic induction wireless charging method, or magnetic resonance wireless charging method; of course, other wireless charging methods can also be used. In a preferred case, as shown in FIGS. 16 and 17, the wireless charging assembly includes a fixed member 71, an induction coil 72, an inductive element 73, a first circuit board 74, and a second circuit board 75; the fixed member 71 is arranged on other apparatuses, and the fixed member 71 is connected with the water box 1; the induction coil 72 and the inductive element 73 are both arranged on the fixed member 71, and the induction coil 72 is sleeved on an outer side of the inductive element 73; the first circuit board 74 is connected with the induction coil 72, and the second circuit board 75 is connected with the inductive element 73. The fixed member 71 can be a fixed bracket, or a fixed plate, or another fixed structure. The induction coil 72 is connected to the atomization sheet 2 through the wire harness 4, or the first circuit board 74 is connected to the atomization sheet 2 through the wire harness 4. The second circuit board 75 is connected to a power source through a wire harness. The inductive element 73 generates a certain current in the induction coil 72 through electromagnetic induction based on a certain frequency of AC electricity, thereby transferring electrical energy from the inductive element 73 to the induction coil 72, and achieving power supply to the atomization sheet 2. By using this wireless charging method, the arrangement of wire harness between the inductive element 73 and the induction coil 72 is omitted. Of course, as an alternative, wired connection can also be used to provide power to the atomization sheet 2.

Preferably, as shown in FIGS. 16 and 17, the fixed member 71 includes a fixed inner plate 711 and a fixed outer plate 712; the fixed inner plate 711 is connected with the water box 1, and the fixed outer plate 712 is fixed on other apparatuses; the fixed outer plate 712 is formed with a first hollow columnar structure 712a, and the fixed inner plate 711 is formed with a second hollow columnar structure 711a; the second hollow columnar structure 711a is sleeved on the first hollow columnar structure 712a, the induction coil 72 is sleeved on the second hollow columnar structure 711a, and the inductive element 73 is arranged in the first hollow columnar structure 712a; the first circuit board 74 is arranged on the fixed inner plate 711, and the second circuit board 75 is arranged on the fixed outer plate 712. The first hollow columnar structure 712a is formed on a side of the fixed outer plate 712 that is close to the fixed inner plate 711. The second hollow columnar structure 711a is formed on a side of the fixed inner plate 711 that is away from the fixed outer plate 712. A diameter of outer tube wall of the first hollow columnar structure 712a is preferably equal to a diameter of inner tube wall of the second hollow columnar structure 711a, so that the first hollow columnar structure 712a and the second hollow columnar structure 711a can be positioned with each other. The first hollow columnar structure 712a and the second hollow columnar structure 711a are made of insulative materials such as glass, plastic, or ceramics. Not using metals can avoid electromagnetic shielding. It should be noted that the end of the first hollow columnar structure 712a and the end of the second hollow columnar structure 711a are preferably both closed. Through such an arrangement, the fixed outer plate 712 can serve as an installation base for the fixed inner plate 711. The fixed outer plate 712 can be fixed on other apparatuses. When it is necessary to add the solvent into the water box 1 or replace the solvent, the fixed inner plate 711 can be detached from the fixed outer plate 712. Then during installation, the fixed inner plate 711 can be installed on the fixed outer plate 712. The first hollow columnar structure 712a and the second hollow columnar structure 711a can play a role of positioning during installation. At the same time, the first hollow columnar structure 712a can accommodate the inductive element 73, and the induction coil 72 can be sleeved outside the second hollow columnar structure 711a, so that both the first hollow columnar structure 712a and the second hollow columnar structure 711a have multiple functions, thereby further improving the compactness of the atomization device. In addition, a magnetic adsorption structure can be arranged between the fixed inner plate 711 and the fixed outer plate 712. For example, a first permanent magnet is arranged on the fixed outer plate 712, and a second permanent magnet is arranged on the fixed inner plate 711. The magnetic properties of the first permanent magnet and the second permanent magnet are opposite, thereby achieving magnetic adsorption fixation of the fixed inner plate 711 by the fixed outer plate 712.

Preferably, an installation port is formed on the water box 1, an installation rib is formed on an inner wall of the installation port, and an installation groove is formed at an edge of the fixed inner plate 711; the installation rib is arranged in the installation groove to fix the fixed inner plate 711 on the water box 1. The installation port can be a square port or a semi-circular port, as long as it can allow the fixed inner plate 711 to enter the installation port. For example, in the structures shown in FIGS. 16 and 17, the installation port is a square port, a U-shaped installation rib 1f is formed on the inner wall of the square port, and the edge of the fixed inner plate 711 is formed with a U-shaped installation groove 711b. The fixed inner plate 711 is inserted into the installation port from one side of the installation port, and two sides of the U-shaped installation rib 1f are first engaged with two sides of the U-shaped installation groove 71 1b through insertion. When inserted in place, all three sides of the U-shaped installation rib 1f are engaged with three sides of the U-shaped installation groove 711b through insertion. The decorative shell 3 can be used to abut against the bottom of the fixed inner plate 711. That is, during installation, the fixed inner plate 711 is first installed on the water box 1, and then the decorative shell 3 is snap-fitted on the water box 1. The decorative shell 3 can not only bear the bottom of the fixed inner plate 711, but also can seal the electrical chamber 1c.

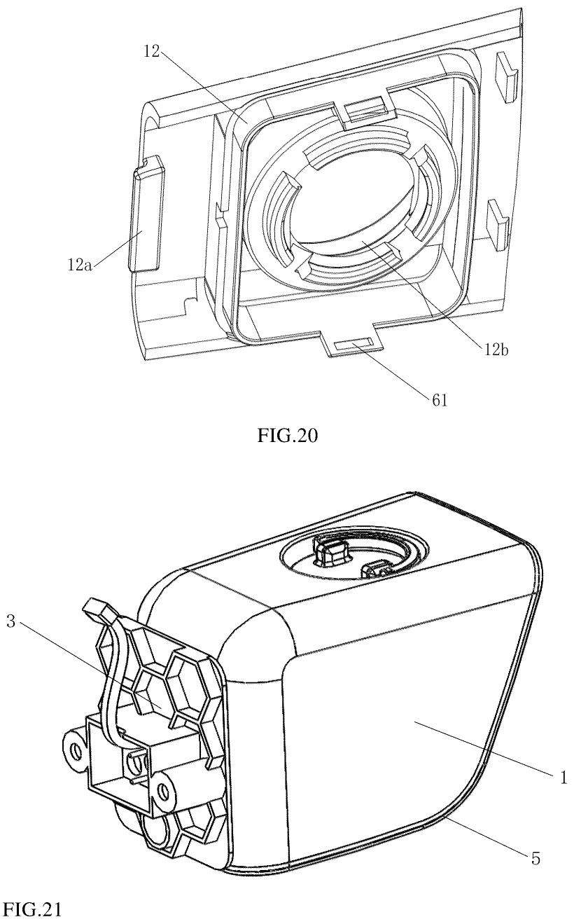

In the present disclosure, the water box 1 can have an integrated structure or a split structure. The split structure can facilitate the cleaning of the interior of the water box 1. For example, as shown in FIGS. 16 to 20, the water box 1 includes a box body 11 and a box cover 12; the box body 11 is arranged on other apparatuses, and the outlet 1a is formed on the box body 11; an abutment member and a snap-fit member are arranged between the box cover 12 and the box body 11; and when the box cover 12 and the box body 11 are installed, the box cover 12 is first abutted onto the box body 11 through the abutment member, and then the box cover 12 and the box body 11 are snap-fitted and fixed through the snap-fit member. The abutment member can be an abutment rib, or a structure in which an abutment rib matches with an abutment groove. For example, an abutment rib can be formed on the box cover 12. An L-shaped abutment rib 12a is shown in FIGS. 16 and 20. During installation, the L-shaped abutment rib 12a can be abutted against an edge of a box opening 11a formed on the box body 11 and matched with the box cover 12. Then, the box cover 12 can be snap-fitted with the box body 11 through the snap-fit member so that the box cover 12 can cover and close the box opening 11a. Preferably, a sealing member 5 is arranged between the box body 11 and the box cover 12, and a through opening is formed on the sealing member 5; the snap-fit member includes a first snap-fit element 61 arranged on the box cover 12 and a second snap-fit element 62 arranged on the box body 11, and the first snap-fit element 61 passes through the through opening and is snap-fitted and fixed with the second snap-fit element 62. The sealing member 5 can be a scaling ring, or a sealing gasket, or other scaling structures. Through the cooperation of the through opening and the first snap-fit element 61, the first snap-fit element 61 can not only be snap-fitted with the second snap-fit element 62 to achieve the installation of the box cover 12 and the box body 11, but also can position the sealing member 5 to prevent the scaling member 5 from moving when the box cover 12 covers and closes the box opening 11a. Of course, a positioning protrusion can also be formed on the scaling member 5, and a positioning groove can be formed on the box cover 12. The positioning protrusion is mated with the positioning groove. Taking the sealing member 5 being a square ring-shaped scaling gasket as an example, there can be two first snap-fit elements 61, which are located on a pair of sides of the square ring-shaped sealing gasket; and there are two positioning protrusions, which are located on the other pair of sides of the square ring-shaped sealing gasket. When the box cover 12 covers and closes the box opening 11a, the mating between the first snap-fit elements 61 and the through opening can achieve the positioning of one pair of sides of the square ring-shaped scaling gasket, and the mating between the positioning protrusions and the positioning grooves can achieve the positioning of the other pair of sides of the square ring-shaped sealing gasket, ensuring that all four sides of the square ring-shaped scaling gasket can be positioned and that the square ring-shaped scaling gasket will not move or deform. In a preferred case, the first snap-fit element 61 is a snap-fit plate with a snap-fit opening, and the second snap-fit element 62 is a snap-fit protrusion. During installation, the snap-fit plate passes through the through opening and exposes the snap-fit opening so that the snap-fit opening is snap-fitted with the snap-fit protrusion. Of course, the first snap-fit element 61 and the second snap-fit element 62 can also use other snap-fit methods.

Preferably, the atomization device further includes a feeding cover 13, and a feeding port 12b is formed on the box cover 12; a first spiral groove is formed on the feeding cover 13, a second spiral groove is formed on the feeding port 12b, and the feeding cover 13 is screw-connected with the feeding port 12b through the first spiral groove and the second spiral groove. Specifically, the screw connection between the feeding cover 13 and the feeding port 12b enables the feeding cover 13 to screw in and out relative to the feeding port 12b. That is, rotating the feeding cover 13 in one direction enables the feeding cover 13 to screw in and close the feeding port 12b, and rotating the feeding cover 13 in the other direction enables the feeding cover 13 to screw out and open the feeding port 12b. Of course, the feeding cover 13 and the feeding port 12c can also adopt a flip over structure with a pivotal connection. A sealing ring can be arranged between the feeding cover 13 and the feeding port 12b.

Preferably, a handle ring 14 is rotatably connected with an outer surface of the feeding cover 13, and the handle ring 14 can rotate in a non-pulling state and be accommodated in the feeding port 12b. The handle ring 14 can be connected to the outer surface of the feeding cover 13 through pivotal connection. After the feeding port 12b is closed by the feeding cover 13, the outer surface of the feeding cover 13 has a certain distance from an outer edge of the feeding port 12b. This distance ensures that the handle ring 14 in the non-pulling state can be accommodated. In this state, the plane where the handle ring 14 is located is parallel to the plane where the outer surface of the feeding cover 13 is located. When the handle ring 14 is in a pulling state (for example, the handle ring 14 exposes the feeding port 12b, making it easier for the user to grip), the plane where the handle ring 14 is located is perpendicular to or at a certain angle to the plane where the outer surface of the feeding cover 13 is located, so that twisting the handle ring 14 enables the feeding cover 13 to screw out of the feeding port 12b.

The clothing treatment apparatus of the present disclosure includes a cabinet, a clothing treatment cylinder, and a door device; the clothing treatment cylinder is arranged in the cabinet, and a clothing throw-in port is formed on the cabinet; the door device is configured to open and close the clothing throw-in port, and the clothing throw-in port is connected with the clothing treatment cylinder through a connecting member; the clothing treatment apparatus further includes an atomization device accommodating a clothing treatment agent; the water box of the atomization device is arranged on the clothing treatment cylinder, the door device and/or the connecting member, and the atomization device has at least one outlet arranged toward an interior of the clothing treatment cylinder so that the atomization device can spray atomized gas into the clothing treatment cylinder. When the clothing treatment apparatus is a clothing dryer, the clothing treatment cylinder is a drying cylinder. When the drying cylinder is a single cylinder structure, the water box of the atomization device is preferably arranged on the door device and/or the connecting member. At this time, the connecting member is a front support structure of the clothing dryer. A front end of the front support structure is connected with the clothing throw-in port of the cabinet, and a rear end of the front support structure is connected with a front end of the drying cylinder through a dynamic scaling structure. The front support structure not only supports the front end of the drying cylinder, but also does not affect the rotation of the drying cylinder. When the clothing treatment apparatus is a washing-drying integrated machine, the clothing treatment cylinder is a washing and drying cylinder, and the clothing treatment cylinder is a sleeve structure, that is, the clothing treatment cylinder has an outer cylinder and an inner cylinder (also known as a drum) rotatably arranged in the outer cylinder. The water box of the atomization device can be arranged on the outer cylinder, the door device and/or the connecting member. At this time, the connecting member is a window gasket. A front end of the window gasket is connected with the clothing throw-in port, and a rear end of the window gasket is connected with the outer cylinder. The window gasket is used to ensure sealing between the outer cylinder and the clothing throw-in port. In the present disclosure, the clothing treatment agent can be water, or detergent, softener, softening agent, fragrance enhancer, or another clothing treatment solvent, or a mixture of the aforementioned water and solvents. The atomized gas is droplets with a large number of small particles formed. Since it is not easy to observe each small droplet with the naked eye, a gas like structure is formed. The atomization device can disperse the clothing treatment agent and dispense it onto the clothing in the clothing treatment cylinder.

### Fourth Embodiment

In view of the problems that existing atomization devices have limited application scenes and a large number of wire harnesses are not advantageous for arrangement, the present disclosure provides an atomization device and a clothing treatment apparatus, aiming to enrich the application scenes of atomization devices, reduce the use of wire harnesses, and prevent the volume of the atomization devices from being too large due to limited arrangement space for wire harnesses.

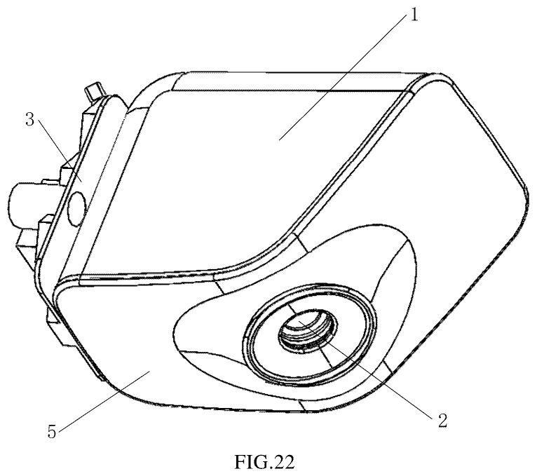

Specifically, as shown in FIGS. 21 to 27, the atomization device of the present disclosure includes a water box 1, an atomization sheet 2 and a wireless charging assembly 31; an outlet 1a is formed on the water box 1, and the atomization sheet 2 is arranged at the outlet 1a; a water containing chamber 1b and an electrical chamber 1c isolated from each other are formed inside the water box 1, and the water containing chamber 1b is communicated with the outlet 1a; the wireless charging assembly 3 includes a fixed member 31, an induction coil 32, an inductive element 33, a first circuit board 34, and a second circuit board 35; the fixed member 31 is connected with the water box 1, the induction coil 32 and the inductive element 33 are both arranged on the fixed member 31, and the induction coil 32 is sleeved on an outer side of the inductive element 33; the first circuit board 34 is connected with the induction coil 32, and the second circuit board 35 is connected with the inductive element 33; the induction coil 32 or the first circuit board 34 is connected with the atomization sheet 2 through a wire harness 4, and the wire harness 4 is located in the electrical chamber 1c. The induction coil 32 can directly supply power to the atomization sheet 2, or the induction coil 32 can directly supply power to the first circuit board 34, and then the first circuit board 34 supplies power to the atomization sheet 2 and controls the atomization sheet 2. The fixed member 31 can be a fixed bracket, or a fixed plate, or other fixed structures. The induction coil 32 is connected to the atomization sheet 2 through the wire harness 4, or the first circuit board 34 is connected to the atomization sheet 2 through the wire harness 4. The second circuit board 35 is connected to a power supply through a wire harness, and the inductive element 33 generates a certain current in the induction coil 32 through electromagnetic induction based on a certain frequency of AC electricity, thereby transferring electrical energy from the inductive element 33 to the induction coil 32, and achieving power supply to the atomization sheet 2. By using this wireless charging method, the arrangement of wire harness between the inductive element 33 and the induction coil 32 is omitted, which is advantageous for spatial layout. Moreover, the electrical chamber 1c can be made into a closed type, without the need to provide holes on the electrical chamber 1c for passage of wire harnesses, thus preventing dust and other dirt from entering.

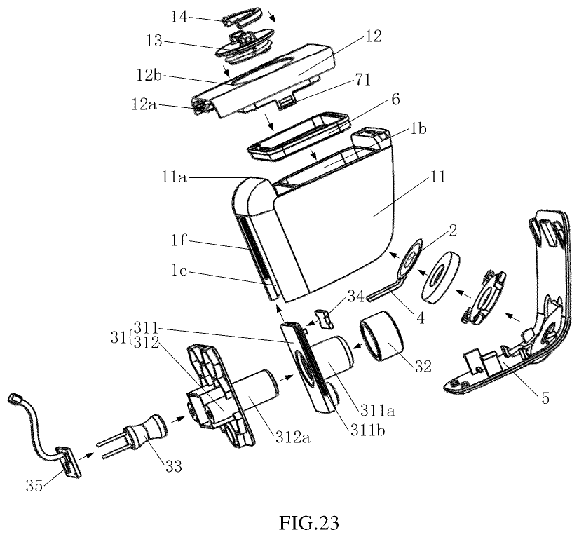

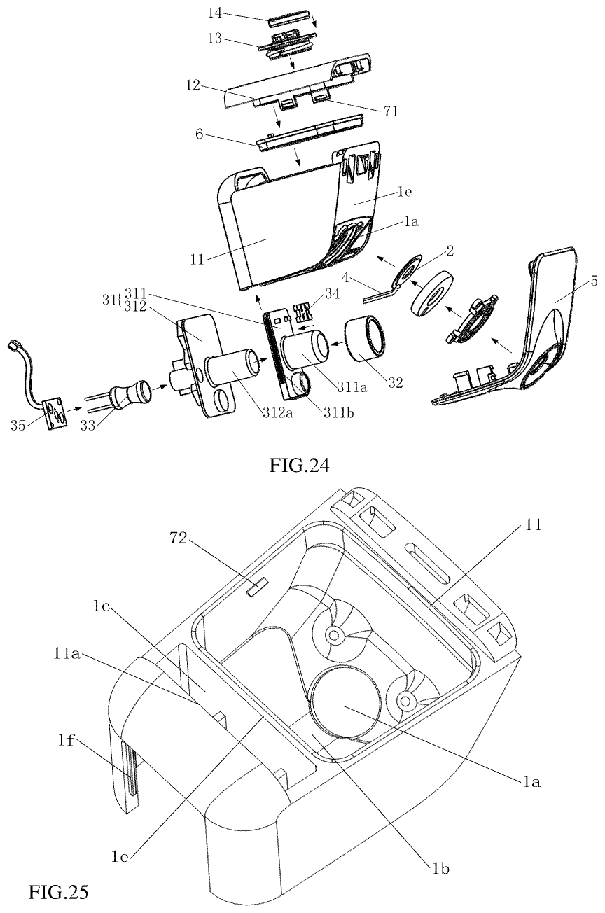

Preferably, as shown in FIGS. 23 and 24, the fixed member 31 includes a fixed inner plate 311 and a fixed outer plate 312; the fixed inner plate 311 is connected with the water box 1, and the fixed outer plate 312 is fixed on other apparatuses; the fixed outer plate 312 is formed with a first hollow columnar structure 312a, and the fixed inner plate 311 is formed with a second hollow columnar structure 311a; the second hollow columnar structure 311a is sleeved on the first hollow columnar structure 312a, the induction coil 32 is sleeved on the second hollow columnar structure 311a, and the inductive element 33 is arranged in the first hollow columnar structure 312a; the first circuit board 34 is arranged on the fixed inner plate 311, and the second circuit board 35 is arranged on the fixed outer plate 312. The first hollow columnar structure 312a is formed on a side of the fixed outer plate 312 that is close to the fixed inner plate 311. The second hollow columnar structure 311a is formed on a side of the fixed inner plate 311 that is away from the fixed outer plate 312. A diameter of outer tube wall of the first hollow columnar structure 312a is preferably equal to a diameter of inner tube wall of the second hollow columnar structure 311a, so that the first hollow columnar structure 312a and the second hollow columnar structure 311a can be positioned with each other. The first hollow columnar structure 312a and the second hollow columnar structure 311a are made of insulative materials such as glass, plastic, or ceramics. Not using metals can avoid electromagnetic shielding. It should be noted that the end of the first hollow columnar structure 312a and the end of the second hollow columnar structure 311a are preferably both closed. Through such an arrangement, the fixed outer plate 312 can serve as an installation base for the fixed inner plate 311. The fixed outer plate 312 can be fixed on other apparatuses. When it is necessary to add the solvent into the water box 1 or replace the solvent, the fixed inner plate 311 can be detached from the fixed outer plate 312. Then during installation, the fixed inner plate 311 can be installed on the fixed outer plate 312. The first hollow columnar structure 312a and the second hollow columnar structure 311a can play a role of positioning during installation. At the same time, the first hollow columnar structure 312a can accommodate the inductive element 33, and the induction coil 32 can be sleeved outside the second hollow columnar structure 311a, so that both the first hollow columnar structure 312a and the second hollow columnar structure 311a have multiple functions, thereby further improving the compactness of the atomization device. In addition, a magnetic adsorption structure can be arranged between the fixed inner plate 311 and the fixed outer plate 312. For example, a first permanent magnet is arranged on the fixed outer plate 312, and a second permanent magnet is arranged on the fixed inner plate 311. The magnetic properties of the first permanent magnet and the second permanent magnet are opposite, thereby achieving magnetic adsorption fixation of the fixed inner plate 311 by the fixed outer plate 312.

Preferably, an installation port is formed on the water box 1, an installation rib is formed on an inner wall of the installation port, and an installation groove is formed at an edge of the fixed inner plate 311; the installation rib is arranged in the installation groove to fix the fixed inner plate 311 on the water box 1. The installation port can be a square port or a semi-circular port, as long as it can allow the fixed inner plate 311 to enter the installation port. For example, in the structures shown in FIGS. 23 and 24, the installation port is a square port, a U-shaped installation rib 1f is formed on the inner wall of the square port, and the edge of the fixed inner plate 311 is formed with a U-shaped installation groove 311b. The fixed inner plate 311 is inserted into the installation port from one side of the installation port, and two sides of the U-shaped installation rib 1f are first engaged with two sides of the U-shaped installation groove 31 1b through insertion. When inserted in place, all three sides of the U-shaped installation rib 1f are engaged with three sides of the U-shaped installation groove 311b through insertion. The decorative shell 5 can be used to abut against the bottom of the fixed inner plate 311. That is, during installation, the fixed inner plate 311 is first installed on the water box 1, and then the decorative shell 5 is snap-fitted on the water box 1. The decorative shell 5 can not only bear the bottom of the fixed inner plate 311, but also can seal the electrical chamber 1c.

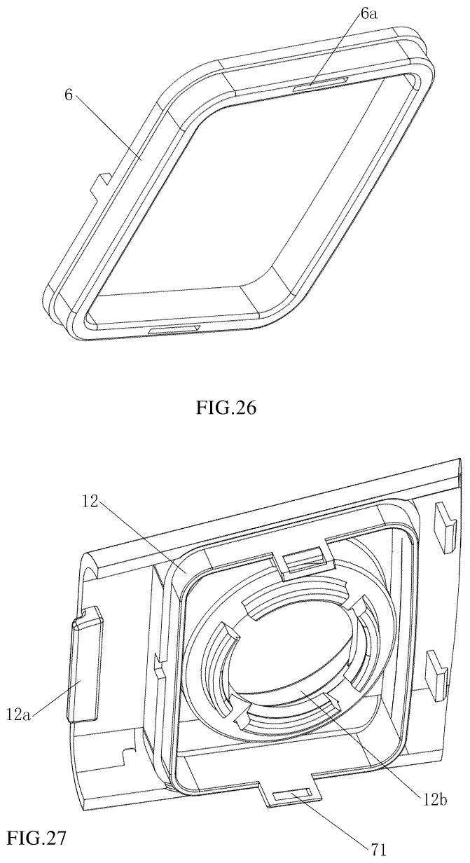

In the present disclosure, the water box 1 can have an integrated structure or a split structure. The split structure can facilitate the cleaning of the interior of the water box 1. For example, as shown in FIGS. 23 to 27, the water box 1 includes a box body 11 and a box cover 12; the box body 11 is arranged on other apparatuses, and the outlet 1a is formed on the box body 11; an abutment member and a snap-fit member are arranged between the box cover 12 and the box body 11; and when the box cover 12 and the box body 11 are installed, the box cover 12 is first abutted onto the box body 11 through the abutment member, and then the box cover 12 and the box body 11 are snap-fitted and fixed through the snap-fit member. The abutment member can be an abutment rib, or a structure in which an abutment rib matches with an abutment groove. For example, an abutment rib can be formed on the box cover 12. An L-shaped abutment rib 12a is shown in FIGS. 23 and 27. During installation, the L-shaped abutment rib 12a can be abutted against an edge of a box opening 11a formed on the box body 11 and matched with the box cover 12. Then, the box cover 12 can be snap-fitted with the box body 11 through the snap-fit member so that the box cover 12 can cover and close the box opening 11a. Preferably, a sealing member 6 is arranged between the box body 11 and the box cover 12, and a through opening 6a is formed on the sealing member 6; the snap-fit member includes a first snap-fit element 71 arranged on the box cover 12 and a second snap-fit element 72 arranged on the box body 11, and the first snap-fit element 71 passes through the through opening 6a and is snap-fitted and fixed with the second snap-fit element 72. The sealing member 6 can be a sealing ring, or a sealing gasket, or other scaling structures. Through the cooperation of the through opening 6a and the first snap-fit element 71, the first snap-fit element 71 can not only be snap-fitted with the second snap-fit element 72 to achieve the installation of the box cover 12 and the box body 11, but also can position the sealing member 6 to prevent the sealing member 6 from moving when the box cover 12 covers and closes the box opening 11a. Of course, a positioning protrusion can also be formed on the sealing member 6, and a positioning groove can be formed on the box cover 12. The positioning protrusion is mated with the positioning groove. Taking the sealing member 6 being a square ring-shaped scaling gasket as an example, there can be two first snap-fit elements 71, which are located on a pair of sides of the square ring-shaped sealing gasket; and there are two positioning protrusions, which are located on the other pair of sides of the square ring-shaped sealing gasket. When the box cover 12 covers and closes the box opening 11a, the mating between the first snap-fit elements 71 and the through opening 6a can achieve the positioning of one pair of sides of the square ring-shaped sealing gasket, and the mating between the positioning protrusions and the positioning grooves can achieve the positioning of the other pair of sides of the square ring-shaped scaling gasket, ensuring that all four sides of the square ring-shaped sealing gasket can be positioned and that the square ring-shaped scaling gasket will not move or deform. In a preferred case, the first snap-fit element 71 is a snap-fit plate with a snap-fit opening, and the second snap-fit element 72 is a snap-fit protrusion. During installation, the snap-fit plate passes through the through opening 6a and exposes the snap-fit opening so that the snap-fit opening is snap-fitted with the snap-fit protrusion. Of course, the first snap-fit element 71 and the second snap-fit element 72 can also use other snap-fit methods.

Preferably, the atomization device further includes a feeding cover 13, and a feeding port 12b is formed on the box cover 12; a first spiral groove is formed on the feeding cover 13, a second spiral groove is formed on the feeding port 12b, and the feeding cover 13 is screw-connected with the feeding port 12b through the first spiral groove and the second spiral groove. Specifically, the screw connection between the feeding cover 13 and the feeding port 12b enables the feeding cover 13 to screw in and out relative to the feeding port 12b. That is, rotating the feeding cover 13 in one direction enables the feeding cover 13 to screw in and close the feeding port 12b, and rotating the feeding cover 13 in the other direction enables the feeding cover 13 to screw out and open the feeding port 12b. Of course, the feeding cover 13 and the feeding port 12c can also adopt a flip over structure with a pivotal connection. A sealing ring can be arranged between the feeding cover 13 and the feeding port 12b.

Preferably, a handle ring 14 is rotatably connected with an outer surface of the feeding cover 13, and the handle ring 14 can rotate in a non-pulling state and be accommodated in the feeding port 12b. The handle ring 14 can be connected to the outer surface of the feeding cover 13 through pivotal connection. After the feeding port 12b is closed by the feeding cover 13, the outer surface of the feeding cover 13 has a certain distance from an outer edge of the feeding port 12b. This distance ensures that the handle ring 14 in the non-pulling state can be accommodated. In this state, the plane where the handle ring 14 is located is parallel to the plane where the outer surface of the feeding cover 13 is located. When the handle ring 14 is in a pulling state (for example, the handle ring 14 exposes the feeding port 12b, making it easier for the user to grip), the plane where the handle ring 14 is located is perpendicular to or at a certain angle to the plane where the outer surface of the feeding cover 13 is located, so that twisting the handle ring 14 enables the feeding cover 13 to screw out of the feeding port 12b.

The clothing treatment apparatus of the present disclosure includes a cabinet, a clothing treatment cylinder, and a door device; the clothing treatment cylinder is arranged in the cabinet, and a clothing throw-in port is formed on the cabinet; the door device is configured to open and close the clothing throw-in port, and the clothing throw-in port is connected with the clothing treatment cylinder through a connecting member; the clothing treatment apparatus further includes an atomization device accommodating a clothing treatment agent; the water box 1 of the atomization device is arranged on the clothing treatment cylinder, the door device and/or the connecting member, and the atomization device has at least one outlet 1a arranged toward an interior of the clothing treatment cylinder so that the atomization device can spray atomized gas into the clothing treatment cylinder. When the clothing treatment apparatus is a clothing dryer, the clothing treatment cylinder is a drying cylinder. When the drying cylinder is a single cylinder structure, the water box 1 of the atomization device is preferably arranged on the door device and/or the connecting member. At this time, the connecting member is a front support structure of the clothing dryer. A front end of the front support structure is connected with the clothing throw-in port of the cabinet, and a rear end of the front support structure is connected with a front end of the drying cylinder through a dynamic sealing structure. The front support structure not only supports the front end of the drying cylinder, but also does not affect the rotation of the drying cylinder. When the clothing treatment apparatus is a washing-drying integrated machine, the clothing treatment cylinder is a washing and drying cylinder, and the clothing treatment cylinder is a sleeve structure, that is, the clothing treatment cylinder has an outer cylinder and an inner cylinder (also known as a drum) rotatably arranged in the outer cylinder. The water box 1 of the atomization device can be arranged on the outer cylinder, the door device and/or the connecting member. At this time, the connecting member is a window gasket. A front end of the window gasket is connected with the clothing throw-in port, and a rear end of the window gasket is connected with the outer cylinder. The window gasket is used to ensure sealing between the outer cylinder and the clothing throw-in port. In the present disclosure, the clothing treatment agent can be water, or detergent, softener, softening agent, fragrance enhancer, or another clothing treatment solvent, or a mixture of the aforementioned water and solvents. The atomized gas is droplets with a large number of small particles formed. Since it is not easy to observe each small droplet with the naked eye, a gas like structure is formed. The atomization device can disperse the clothing treatment agent and dispense it onto the clothing in the clothing treatment cylinder.

### Fifth Embodiment

In view of the problems that existing atomization devices have limited application scenes and have the safety hazard of being prone to short circuit, the present disclosure provides an atomization device and a clothing treatment apparatus, aiming to enrich the application scenes of atomization devices, avoid occurrence of short circuit, improve the electrical safety of atomization devices, and ensure the compactness of overall structure.

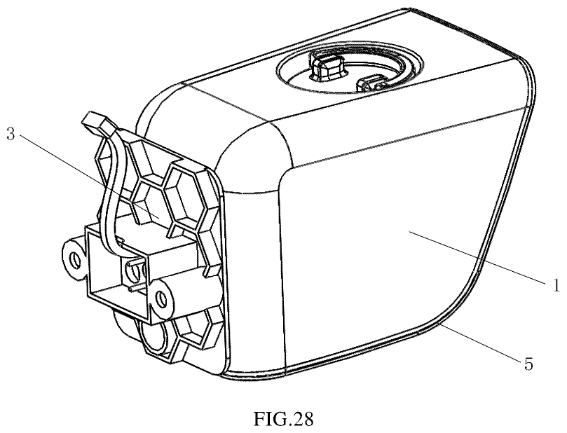

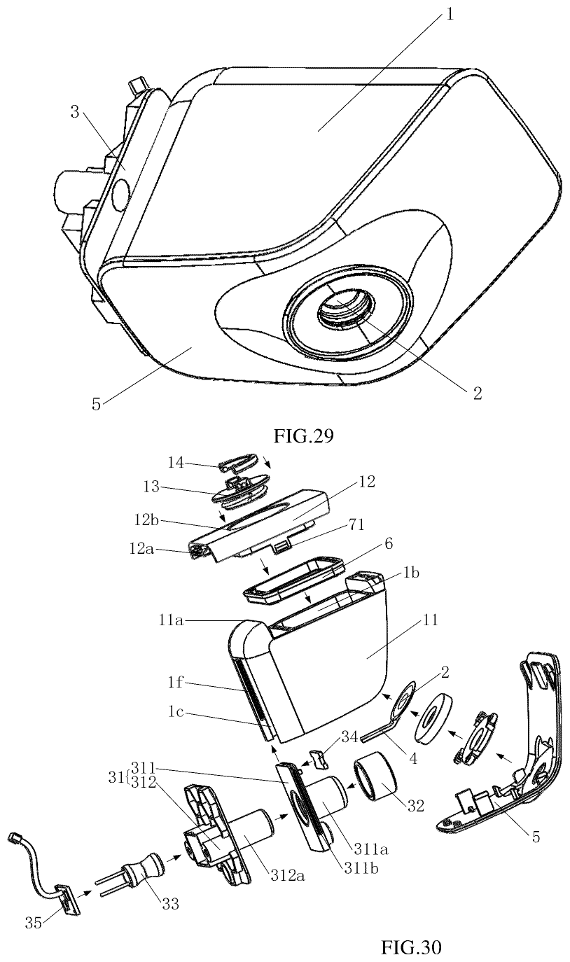

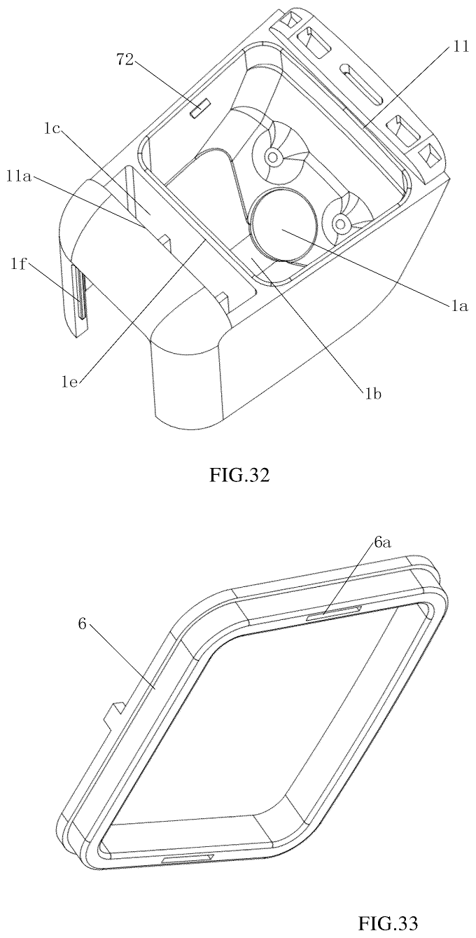

Specifically, as shown in FIGS. 28 to 34, the atomization device of the present disclosure includes a water box 1, an atomization sheet 2 and a wireless charging assembly 3; an outlet 1a is formed on the water box 1, and the atomization sheet 2 is arranged at the outlet 1a; a water containing chamber 1b and an electrical chamber le isolated from each other are formed inside the water box 1; for example, a partition structure 1e divides the interior of the water box 1 into a water containing chamber 1b and an electrical chamber 1c that are independent from each other, and the water containing chamber 1b is communicated with the outlet 1a; an installation port is also formed on the water box 1, and the wireless charging assembly 3 is fixed on the installation port; the wireless charging assembly 3 is connected with the atomization sheet 2 through a wire harness 4, and the wire harness 4 is located in the electrical chamber 1c. The installation port can be square or semi-circular, as long as it can allow the wireless charging assembly 3 to enter the installation port. Th wireless charging assembly 3 can adopt electromagnetic induction wireless charging method, or magnetic resonance wireless charging method; of course, other wireless charging methods can also be used. Th wireless charging assembly 3 can be inserted into the installation port, or snap-fitted into the installation port, or magnetically adsorbed into the installation port, which can be flexibly set by those skilled in the art.

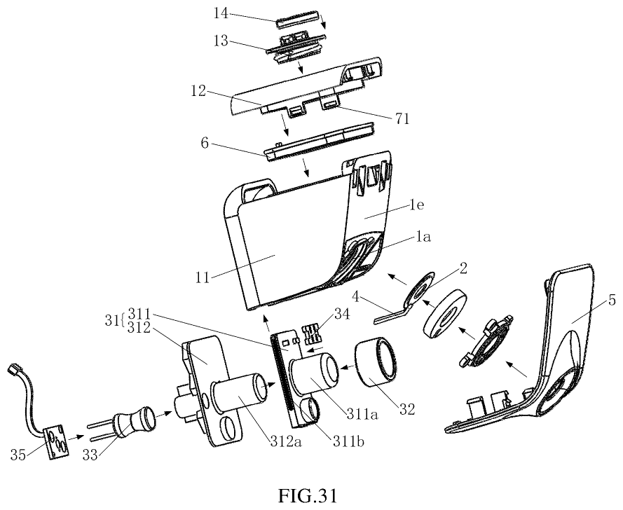

Preferably, as shown in FIGS. 30 and 31, the wireless charging assembly 3 includes a fixed member 31, an induction coil 32, an inductive element 33, a first circuit board 34, and a second circuit board 35; the induction coil 32 and the inductive element 33 are both arranged on the fixed member 31, and the induction coil 32 is sleeved on an outer side of the inductive element 33; the first circuit board 34 is connected with the induction coil 32, and the second circuit board 35 is connected with the inductive element 33. An installation groove is formed on the fixed member 31, an installation rib is formed on an inner wall of the installation port, and the installation rib is arranged in the installation groove to fix the fixed member 31 on the water box 1. The induction coil 32 can directly supply power to the atomization sheet 2, or the induction coil 32 can directly supply power to the first circuit board 34, and then the first circuit board 34 supplies power to the atomization sheet 2 and controls the atomization sheet 2. The fixed member 31 can be a fixed bracket, or a fixed plate, or other fixed structures. The induction coil 32 is connected to the atomization sheet 2 through the wire harness 4, or the first circuit board 34 is connected to the atomization sheet 2 through the wire harness 4. The second circuit board 35 is connected to a power supply through a wire harness, and the inductive element 33 generates a certain current in the induction coil 32 through electromagnetic induction based on a certain frequency of AC electricity, thereby transferring electrical energy from the inductive element 33 to the induction coil 32, and achieving power supply to the atomization sheet 2. By using this wireless charging method, the arrangement of wire harness between the inductive element 33 and the induction coil 32 is omitted, which is advantageous for spatial layout. Moreover, the electrical chamber 1c can be made into a closed type, without the need to provide holes on the electrical chamber 1c for passage of wire harnesses, thus preventing dust and other dirt from entering.

Preferably, as shown in FIGS. 30 and 31, the fixed member 31 includes a fixed inner plate 311 and a fixed outer plate 312; the fixed inner plate 311 is connected with the water box 1, and the fixed outer plate 312 is fixed on other apparatuses; the fixed outer plate 312 is formed with a first hollow columnar structure 312a, and the fixed inner plate 311 is formed with a second hollow columnar structure 311a; the second hollow columnar structure 311a is sleeved on the first hollow columnar structure 312a, the induction coil 32 is sleeved on the second hollow columnar structure 311a, and the inductive element 33 is arranged in the first hollow columnar structure 312a; the first circuit board 34 is arranged on the fixed inner plate 311, and the second circuit board 35 is arranged on the fixed outer plate 312. The first hollow columnar structure 312a is formed on a side of the fixed outer plate 312 that is close to the fixed inner plate 311. The second hollow columnar structure 311a is formed on a side of the fixed inner plate 311 that is away from the fixed outer plate 312. A diameter of outer tube wall of the first hollow columnar structure 312a is preferably equal to a diameter of inner tube wall of the second hollow columnar structure 311a, so that the first hollow columnar structure 312a and the second hollow columnar structure 311a can be positioned with each other. The first hollow columnar structure 312a and the second hollow columnar structure 311a are made of insulative materials such as glass, plastic, or ceramics. Not using metals can avoid electromagnetic shielding. It should be noted that the end of the first hollow columnar structure 312a and the end of the second hollow columnar structure 311a are preferably both closed. Through such an arrangement, the fixed outer plate 312 can serve as an installation base for the fixed inner plate 311. The fixed outer plate 312 can be fixed on other apparatuses. When it is necessary to add the solvent into the water box 1 or replace the solvent, the fixed inner plate 311 can be detached from the fixed outer plate 312. Then during installation, the fixed inner plate 311 can be installed on the fixed outer plate 312. The first hollow columnar structure 312a and the second hollow columnar structure 311a can play a role of positioning during installation. At the same time, the first hollow columnar structure 312a can accommodate the inductive element 33, and the induction coil 32 can be sleeved outside the second hollow columnar structure 311a, so that both the first hollow columnar structure 312a and the second hollow columnar structure 311a have multiple functions, thereby further improving the compactness of the atomization device. In addition, a magnetic adsorption structure can be arranged between the fixed inner plate 311 and the fixed outer plate 312. For example, a first permanent magnet is arranged on the fixed outer plate 312, and a second permanent magnet is arranged on the fixed inner plate 311. The magnetic properties of the first permanent magnet and the second permanent magnet are opposite, thereby achieving magnetic adsorption fixation of the fixed inner plate 311 by the fixed outer plate 312.

Preferably, the installation groove is formed on the fixed inner plate 311. For example, as shown in FIGS. 30 and 31, the edge of the fixed inner plate 311 is formed with a U-shaped installation groove 311b. The fixed inner plate 311 is inserted into the installation port from one side of the installation port, and two sides of the U-shaped installation rib 1f are first engaged with two sides of the U-shaped installation groove 311b through insertion. When inserted in place, all three sides of the U-shaped installation rib 1f are engaged with three sides of the U-shaped installation groove 311b through insertion. The decorative shell 5 can be used to abut against the bottom of the fixed inner plate 311. That is, during installation, the fixed inner plate 311 is first installed on the water box 1, and then the decorative shell 5 is snap-fitted on the water box 1. The decorative shell 5 can not only bear the bottom of the fixed inner plate 311, but also can seal the electrical chamber 1c. Of course, the decorative shell 5 can also be connected with the water box 1 using other connecting methods.

Preferably, as shown in FIGS. 28 to 32, an opening communicated with the outlet 1a is formed on the decorative shell 5. The opening ensures that the atomization sheet 2 sprays atomized gas to the outside. A plurality of elastic claws can be arranged on the decorative shell 5, and a plurality of snap-fit protrusions can be arranged on the water box 1. The clastic claws are snap-fitted with the snap-fit protrusions in a one-to-one correspondence to achieve the connection between the decorative shell 5 and the water box 1. Positioning ribs can also be arranged on the decorative shell 5, and positioning grooves can be arranged on the water box 1. The positioning ribs are mated with the positioning grooves for positioning. During installation, first, the positioning ribs on the decorative shell 5 are aligned with the positioning grooves on the water box 1. Then, as the positioning ribs gradually go deeper into the positioning grooves, the corresponding elastic claws and snap-fit protrusions are snap-fitted with each other, thus achieving pre-positioning through the positioning grooves and the positioning ribs. Then, the elastic claws and the snap-fit protrusions achieve accurate snap-fit between the decorative shell 5 and the water box 1.

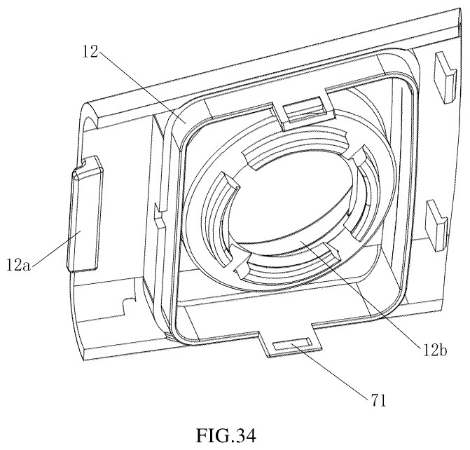

In the present disclosure, the water box 1 can have an integrated structure or a split structure. The split structure can facilitate the cleaning of the interior of the water box 1. For example, as shown in FIGS. 30 to 34, the water box 1 includes a box body 11 and a box cover 12; the box body 11 is arranged on other apparatuses, and the outlet 1a is formed on the box body 11; an abutment member and a snap-fit member are arranged between the box cover 12 and the box body 11; and when the box cover 12 and the box body 11 are installed, the box cover 12 is first abutted onto the box body 11 through the abutment member, and then the box cover 12 and the box body 11 are snap-fitted and fixed through the snap-fit member. The abutment member can be an abutment rib, or a structure in which an abutment rib matches with an abutment groove. For example, an abutment rib can be formed on the box cover 12. An L-shaped abutment rib 12a is shown in FIGS. 30 and 34. During installation, the L-shaped abutment rib 12a can be abutted against an edge of a box opening 11a formed on the box body 11 and matched with the box cover 12. Then, the box cover 12 can be snap-fitted with the box body 11 through the snap-fit member so that the box cover 12 can cover and close the box opening 11a. Preferably, a sealing member 6 is arranged between the box body 11 and the box cover 12, and a through opening 6a is formed on the sealing member 6; the snap-fit member includes a first snap-fit element 71 arranged on the box cover 12 and a second snap-fit element 72 arranged on the box body 11, and the first snap-fit element 71 passes through the through opening 6a and is snap-fitted and fixed with the second snap-fit element 72. The sealing member 6 can be a sealing ring, or a scaling gasket, or other scaling structures. Through the cooperation of the through opening 6a and the first snap-fit element 71, the first snap-fit element 71 can not only be snap-fitted with the second snap-fit element 72 to achieve the installation of the box cover 12 and the box body 11, but also can position the scaling member 6 to prevent the sealing member 6 from moving when the box cover 12 covers and closes the box opening 11a. Of course, a positioning protrusion can also be formed on the sealing member 6, and a positioning groove can be formed on the box cover 12. The positioning protrusion is mated with the positioning groove. Taking the sealing member 6 being a square ring-shaped scaling gasket as an example, there can be two first snap-fit elements 71, which are located on a pair of sides of the square ring-shaped scaling gasket; and there are two positioning protrusions, which are located on the other pair of sides of the square ring-shaped scaling gasket. When the box cover 12 covers and closes the box opening 11a, the mating between the first snap-fit elements 71 and the through opening 6a can achieve the positioning of one pair of sides of the square ring-shaped scaling gasket, and the mating between the positioning protrusions and the positioning grooves can achieve the positioning of the other pair of sides of the square ring-shaped sealing gasket, ensuring that all four sides of the square ring-shaped sealing gasket can be positioned and that the square ring-shaped sealing gasket will not move or deform. In a preferred case, the first snap-fit element 71 is a snap-fit plate with a snap-fit opening, and the second snap-fit element 72 is a snap-fit protrusion. During installation, the snap-fit plate passes through the through opening 6a and exposes the snap-fit opening so that the snap-fit opening is snap-fitted with the snap-fit protrusion. Of course, the first snap-fit element 71 and the second snap-fit element 72 can also use other snap-fit methods.

Preferably, the atomization device further includes a feeding cover 13, and a feeding port 12b is formed on the box cover 12; a first spiral groove is formed on the feeding cover 13, a second spiral groove is formed on the feeding port 12b, and the feeding cover 13 is screw-connected with the feeding port 12b through the first spiral groove and the second spiral groove. Specifically, the screw connection between the feeding cover 13 and the feeding port 12b enables the feeding cover 13 to screw in and out relative to the feeding port 12b. That is, rotating the feeding cover 13 in one direction enables the feeding cover 13 to screw in and close the feeding port 12b, and rotating the feeding cover 13 in the other direction enables the feeding cover 13 to screw out and open the feeding port 12b. Of course, the feeding cover 13 and the feeding port 12c can also adopt a flip over structure with a pivotal connection. A sealing ring can be arranged between the feeding cover 13 and the feeding port 12b.

Preferably, a handle ring 14 is rotatably connected with an outer surface of the feeding cover 13, and the handle ring 14 can rotate in a non-pulling state and be accommodated in the feeding port 12b. The handle ring 14 can be connected to the outer surface of the feeding cover 13 through pivotal connection. After the feeding port 12b is closed by the feeding cover 13, the outer surface of the feeding cover 13 has a certain distance from an outer edge of the feeding port 12b. This distance ensures that the handle ring 14 in the non-pulling state can be accommodated. In this state, the plane where the handle ring 14 is located is parallel to the plane where the outer surface of the feeding cover 13 is located. When the handle ring 14 is in a pulling state (for example, the handle ring 14 exposes the feeding port 12b, making it easier for the user to grip), the plane where the handle ring 14 is located is perpendicular to or at a certain angle to the plane where the outer surface of the feeding cover 13 is located, so that twisting the handle ring 14 enables the feeding cover 13 to screw out of the feeding port 12b.

The clothing treatment apparatus of the present disclosure includes a cabinet, a clothing treatment cylinder, and a door device; the clothing treatment cylinder is arranged in the cabinet, and a clothing throw-in port is formed on the cabinet; the door device is configured to open and close the clothing throw-in port, and the clothing throw-in port is connected with the clothing treatment cylinder through a connecting member; the clothing treatment apparatus further includes an atomization device accommodating a clothing treatment agent; the water box 1 of the atomization device is arranged on the clothing treatment cylinder, the door device and/or the connecting member, and the atomization device has at least one outlet 1a arranged toward an interior of the clothing treatment cylinder so that the atomization device can spray atomized gas into the clothing treatment cylinder. When the clothing treatment apparatus is a clothing dryer, the clothing treatment cylinder is a drying cylinder. When the drying cylinder is a single cylinder structure, the water box 1 of the atomization device is preferably arranged on the door device and/or the connecting member. At this time, the connecting member is a front support structure of the clothing dryer. A front end of the front support structure is connected with the clothing throw-in port of the cabinet, and a rear end of the front support structure is connected with a front end of the drying cylinder through a dynamic sealing structure. The front support structure not only supports the front end of the drying cylinder, but also does not affect the rotation of the drying cylinder. When the clothing treatment apparatus is a washing-drying integrated machine, the clothing treatment cylinder is a washing and drying cylinder, and the clothing treatment cylinder is a sleeve structure, that is, the clothing treatment cylinder has an outer cylinder and an inner cylinder (also known as a drum) rotatably arranged in the outer cylinder. The water box 1 of the atomization device can be arranged on the outer cylinder, the door device and/or the connecting member. At this time, the connecting member is a window gasket. A front end of the window gasket is connected with the clothing throw-in port, and a rear end of the window gasket is connected with the outer cylinder. The window gasket is used to ensure sealing between the outer cylinder and the clothing throw-in port. In the present disclosure, the clothing treatment agent can be water, or detergent, softener, softening agent, fragrance enhancer, or another clothing treatment solvent, or a mixture of the aforementioned water and solvents. The atomized gas is droplets with a large number of small particles formed. Since it is not easy to observe each small droplet with the naked eye, a gas like structure is formed. The atomization device can disperse the clothing treatment agent and dispense it onto the clothing in the clothing treatment cylinder.

### Sixth Embodiment

In view of the problem that existing atomization devices have limited application scenes, the present disclosure provides an atomization device and a clothing treatment apparatus, aiming to enrich the application scenes of atomization devices and facilitate the quick addition of solvent.

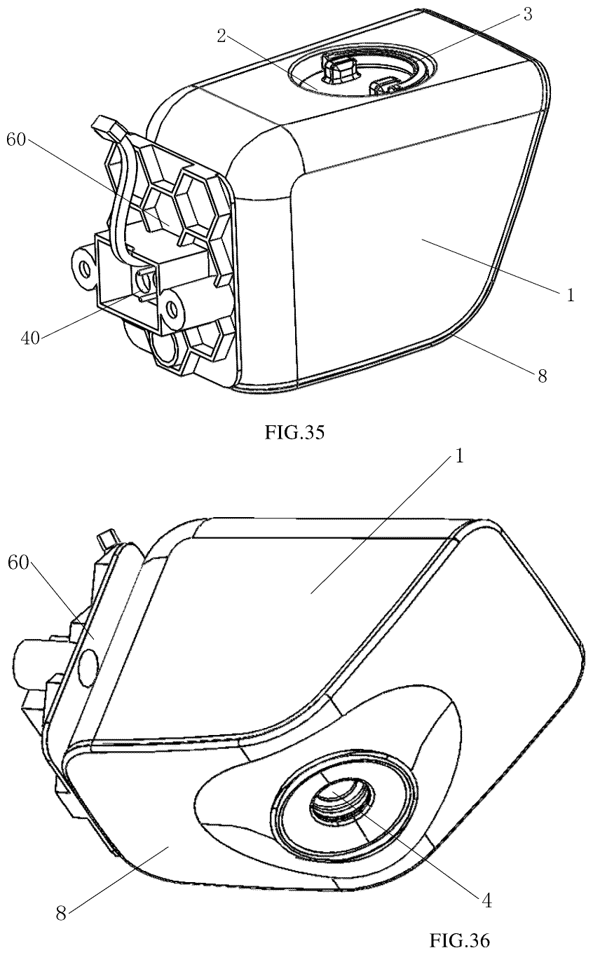

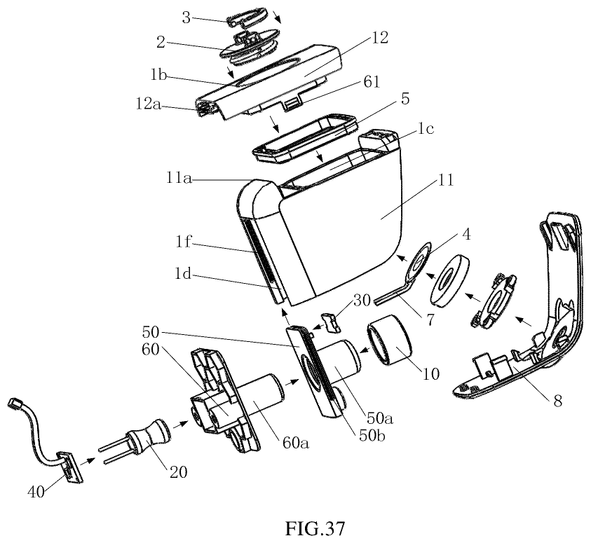

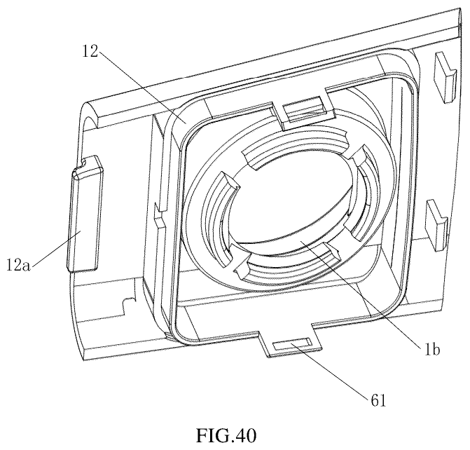

Specifically, as shown in FIGS. 35 to 40, the atomization device of the present disclosure includes a water box 1, a feeding cover 2, a handle ring 3 and an atomization sheet 4; the water box 1 is formed with a feeding port la and an outlet 1b, and the atomization sheet 4 is arranged at the outlet 1a; the handle ring 3 is connected with the feeding cover 2, a first spiral groove is formed on the feeding cover 2, and a second spiral groove is formed on the feeding port 1b; the feeding cover 2 is screw-connected with the feeding port 1b through the first spiral groove and the second spiral groove, and the handle ring 3 is arranged to enable the feeding cover 2 to screw in and out relative to the feeding port 1b. The screw connection between the feeding cover 2 and the feeding port 1b enables the feeding cover 2 to screw in and out relative to the feeding port 1b. That is, rotating the feeding cover 2 in one direction enables the feeding cover 2 to screw in and close the feeding port 1b, and rotating the feeding cover 2 in the other direction enables the feeding cover 2 to screw out and open the feeding port 1b.

Preferably, the handle ring 3 is rotatably connected with an outer surface of the feeding cover 2, and the handle ring 3 can rotate in a non-pulling state and be accommodated in the feeding port 1b. The handle ring 3 can be connected to the outer surface of the feeding cover 2 through pivotal connection. After the feeding port 1b is closed by the feeding cover 2, the outer surface of the feeding cover 2 has a certain distance from an outer edge of the feeding port 1b. This distance ensures that the handle ring 3 in the non-pulling state can be accommodated. In this state, the plane where the handle ring 3 is located is parallel to the plane where the outer surface of the feeding cover 2 is located. When the handle ring 3 is in a pulling state (for example, the handle ring 3 exposes the feeding port 1b, making it easier for the user to grip), the plane where the handle ring 3 is located is perpendicular to or at a certain angle to the plane where the outer surface of the feeding cover 2 is located, so that twisting the handle ring 3 enables the feeding cover 2 to screw out of the feeding port 1b. Of course, as an alternative, the handle ring 3 can also be connected with the feeding cover 2 by insertion or snap-fit, which can be flexibly set by those skilled in the art.

Preferably, a first sealing member is arranged between the feeding cover 2 and the feeding port 1b, and the first sealing member can be a sealing ring, a sealing gasket, or other scaling structures.

Preferably, as shown in FIGS. 37, 38 and 40, the water box 1 includes a box body 11 and a box cover 12, the outlet 1a is formed on the box body 11, and the feeding port 1b is formed on the box cover 12; an abutment member and a snap-fit member are arranged between the box cover 12 and the box body 11; and when the box cover 12 and the box body 11 are installed, the box cover 12 is first abutted onto the box body 11 through the abutment member, and then the box cover 12 and the box body 11 are snap-fitted and fixed through the snap-fit member. The abutment member can be an abutment rib, or a structure in which an abutment rib matches with an abutment groove. For example, an abutment rib can be formed on the box cover 12. An L-shaped abutment rib 12a is shown in FIGS. 37 and 40. During installation, the L-shaped abutment rib 12a can be abutted against an inner side of an edge of a box opening 11a formed on the box body 11 and matched with the box cover 12. Then, the box cover 12 can be snap-fitted with the box body 11 through the snap-fit member so that the box cover 12 can cover and close the box opening 11a. The snap-fit member can be in the form of a claw matching with a snap-fit opening, or in the form of a snap-fit protrusion matching with a snap-fit groove, which can be flexibly set by those skilled in the art.

Preferably, as shown in FIGS. 37 to 40, a second sealing member 5 is arranged between the box body 11 and the box cover 12, and a through opening 5a is formed on the second sealing member 5; the snap-fit member includes a first snap-fit element 61 arranged on the box cover 12 and a second snap-fit element 62 arranged on the box body 11, and the first snap-fit element 61 passes through the through opening 5a and is snap-fitted and fixed with the second snap-fit element 62. The second sealing member 5 can be a sealing ring, or a sealing gasket, or other sealing structures. Through the cooperation of the through opening 5a and the first snap-fit element 61, the first snap-fit element 61 can not only be snap-fitted with the second snap-fit element 62 to achieve the installation of the box cover 12 and the box body 11, but also can position the second sealing member 5 to prevent the second sealing member 5 from moving when the box cover 12 covers and closes the box opening 11a. Of course, a positioning protrusion can also be formed on the second sealing member 5, and a positioning groove can be formed on the box cover 12. The positioning protrusion is mated with the positioning groove. Taking the second sealing member 5 being a square ring-shaped scaling gasket as an example, there can be two first snap-fit elements 61, which are located on a pair of sides of the square ring-shaped sealing gasket; and there are two positioning protrusions, which are located on the other pair of sides of the square ring-shaped sealing gasket. When the box cover 12 covers and closes the box opening 11a, the mating between the first snap-fit element 61 and the through opening 5a can achieve the positioning of one pair of sides of the square ring-shaped sealing gasket, and the mating between the positioning protrusions and the positioning grooves can achieve the positioning of the other pair of sides of the square ring-shaped sealing gasket, ensuring that all four sides of the square ring-shaped scaling gasket can be positioned and that the square ring-shaped sealing gasket will not move or deform. In a preferred case, the first snap-fit element 61 is a snap-fit plate with a snap-fit opening, and the second snap-fit element 62 is a snap-fit protrusion. During installation, the snap-fit plate passes through the through opening 5a and exposes the snap-fit opening so that the snap-fit opening is snap-fitted with the snap-fit protrusion. Of course, the first snap-fit element 61 and the second snap-fit element 62 can also use other snap-fit methods. Of course, in the above, the snap-fit member can also directly snap-fit the box body 11 with the box cover 12 without mating with the second sealing member 5.

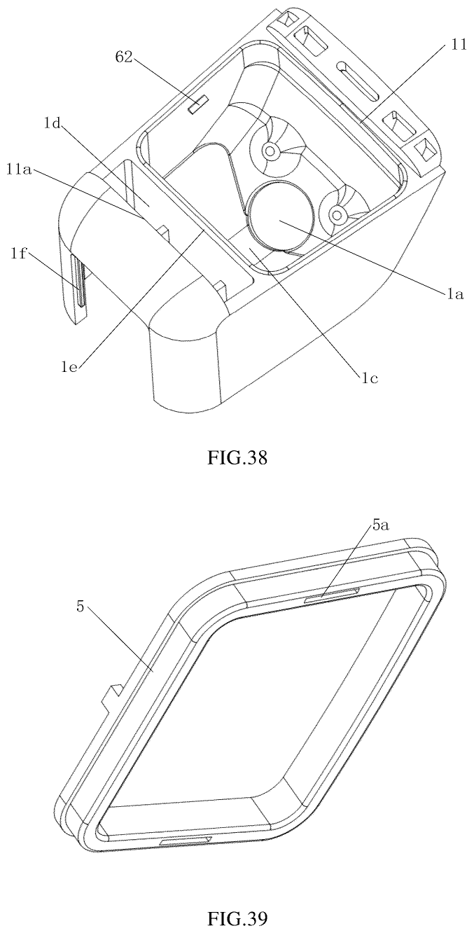

Preferably, as shown in FIGS. 37 and 38, a water containing chamber 1c and an electrical chamber 1d isolated from each other are formed inside the water box 1. Both the feeding port 1b and the outlet 1a are communicated with the water containing chamber 1c, and the electrical chamber 1d is used to accommodate a wire harness 7 connected with the atomization sheet 4. Specifically, the electrical chamber 1d and the water containing chamber 1c can be separated by a partition structure 1e. The partition structure 1e, the box cover 12 and the feeding cover 2 ensure the closure of the water containing chamber 1c. The outlet 1a is formed on the partition structure 1e, and the electrical chamber 1d can be closed or non-closed. In the structure shown in FIG. 37, a lower part of the electrical chamber 1d is closed by a decorative shell 8, and the electrical chamber 1d can accommodate the wire harness 7 connected with the atomization sheet 4, thereby achieving power supply and control of the atomization sheet 4. More preferably, an accommodation groove is formed on an outer side of the partition structure 1e, and the wire harness 7 can be partially accommodated in the accommodation groove, thereby positioning the wire harness 7.

Preferably, the atomization device further includes a wireless charging assembly for supplying power to the atomization sheet 4; the wireless charging assembly is connected with the water box 1, and a part of the wireless charging assembly is located inside the electrical chamber 1d. The wireless charging assembly can adopt electromagnetic induction wireless charging method, or magnetic resonance wireless charging method; of course, other wireless charging methods can also be used. In a preferred case, as shown in FIG. 37, the wireless charging assembly includes a fixed member, an induction coil 10, an inductive element 20, a first circuit board 30, and a second circuit board 40; the fixed member is arranged on other apparatuses, and the fixed member is connected with the water box 1; the induction coil 10 and the inductive element 20 are both arranged on the fixed member, and the induction coil 10 is sleeved on an outer side of the inductive element 20; the first circuit board 30 is connected with the induction coil 10, and the second circuit board 40 is connected with the inductive element 20. The fixed member can be a fixed bracket, or a fixed plate, or another fixed structure. The induction coil 10 is connected to the atomization sheet 4 through the wire harness 7, or the first circuit board 30 is connected to the atomization sheet 4 through the wire harness 7. The second circuit board 40 is connected to a power source through a wire harness. The inductive element 20 generates a certain current in the induction coil 10 through electromagnetic induction based on a certain frequency of AC electricity, thereby transferring electrical energy from the inductive element 20 to the induction coil 10, and achieving power supply to the atomization sheet 4. By using this wireless charging method, the arrangement of wire harness between the inductive element 20 and the induction coil 10 is omitted. Of course, as an alternative, wired connection can also be used to provide power to the atomization sheet 4.

Preferably, as shown in FIG. 37, the fixed member includes a fixed inner plate 50 and a fixed outer plate 60; the fixed inner plate 50 is connected with the water box 1, and the fixed outer plate 60 is fixed on other apparatuses; the fixed outer plate 60 is formed with a first hollow columnar structure 60a, and the fixed inner plate 50 is formed with a second hollow columnar structure 50a; the second hollow columnar structure 50a is sleeved on the first hollow columnar structure 60a, the induction coil 10 is sleeved on the second hollow columnar structure 50a, and the inductive element 20 is arranged in the first hollow columnar structure 60a; the first circuit board 30 is arranged on the fixed inner plate 50, and the second circuit board 40 is arranged on the fixed outer plate 60. The first hollow columnar structure 60a is formed on a side of the fixed outer plate 60 that is close to the fixed inner plate 50. The second hollow columnar structure 50a is formed on a side of the fixed inner plate 50 that is away from the fixed outer plate 60. A diameter of outer tube wall of the first hollow columnar structure 60a is preferably equal to a diameter of inner tube wall of the second hollow columnar structure 50a, so that the first hollow columnar structure 60a and the second hollow columnar structure 50a can be positioned with each other. The first hollow columnar structure 60a and the second hollow columnar structure 50a are made of insulative materials such as glass, plastic, or ceramics. Not using metals can avoid electromagnetic shielding. It should be noted that the end of the first hollow columnar structure 60a and the end of the second hollow columnar structure 50a are preferably both closed. Through such an arrangement, the fixed outer plate 60 can serve as an installation base for the fixed inner plate 50, and the fixed outer plate 60 can be fixed on other apparatuses. When it is necessary to add the solvent into the water box 1 or replace the solvent, the fixed inner plate 50 can be detached from the fixed outer plate 60. Then during installation, the fixed inner plate 50 can be installed on the fixed outer plate 60. The first hollow columnar structure 60a and the second hollow columnar structure 50a can play a role of positioning during installation. At the same time, the first hollow columnar structure 60a can accommodate the inductive element 20, and the induction coil 10 can be sleeved outside the second hollow columnar structure 50a, so that both the first hollow columnar structure 60a and the second hollow columnar structure 50a have multiple functions, thereby further improving the compactness of the atomization device. In addition, a magnetic adsorption structure can be arranged between the fixed inner plate 50 and the fixed outer plate 60. For example, a first permanent magnet is arranged on the fixed outer plate 60, and a second permanent magnet is arranged on the fixed inner plate 50. The magnetic properties of the first permanent magnet and the second permanent magnet are opposite, thereby achieving magnetic adsorption fixation of the fixed inner plate 50 by the fixed outer plate 60.

Preferably, an installation port is formed on the water box 1, an installation rib is formed on an inner wall of the installation port, and an installation groove is formed at an edge of the fixed inner plate 50; the installation rib is arranged in the installation groove to fix the fixed inner plate 50 on the water box 1. The installation port can be a square port or a semi-circular port, as long as it can allow the fixed inner plate 50 to enter the installation port. For example, in the structure shown in FIG. 37, the installation port is a square port, a U-shaped installation rib 1f is formed on the inner wall of the square port, and the edge of the fixed inner plate 50 is formed with a U-shaped installation groove 50b. The fixed inner plate 50 is inserted into the installation port from one side of the installation port, and two sides of the U-shaped installation rib 1f are first engaged with two sides of the U-shaped installation groove 50b through insertion. When inserted in place, all three sides of the U-shaped installation rib 1f are engaged with three sides of the U-shaped installation groove 50b through insertion. When the decorative shell 8 is provided, the decorative shell 8 can abut against the bottom of the fixed inner plate 50. That is, during installation, the fixed inner plate 50 is first installed on the water box 1, and then the decorative shell 8 is snap-fitted on the water box 1. The decorative shell 8 can not only bear the bottom of the fixed inner plate 50, but also can seal the electrical chamber 1d.

The clothing treatment apparatus of the present disclosure includes a cabinet, a clothing treatment cylinder, and a door device; the clothing treatment cylinder is arranged in the cabinet, and a clothing throw-in port is formed on the cabinet; the door device is configured to open and close the clothing throw-in port, and the clothing throw-in port is connected with the clothing treatment cylinder through a connecting member; the clothing treatment apparatus further includes an atomization device accommodating a clothing treatment agent; the water box 1 of the atomization device is arranged on the clothing treatment cylinder, the door device and/or the connecting member, and the atomization device has at least one outlet 1a arranged toward an interior of the clothing treatment cylinder so that the atomization device can spray atomized gas into the clothing treatment cylinder. When the clothing treatment apparatus is a clothing dryer, the clothing treatment cylinder is a drying cylinder. When the drying cylinder is a single cylinder structure, the water box 1 of the atomization device is preferably arranged on the door device and/or the connecting member. At this time, the connecting member is a front support structure of the clothing dryer. A front end of the front support structure is connected with the clothing throw-in port of the cabinet, and a rear end of the front support structure is connected with a front end of the drying cylinder through a dynamic sealing structure. The front support structure not only supports the front end of the drying cylinder, but also does not affect the rotation of the drying cylinder. When the clothing treatment apparatus is a washing-drying integrated machine, the clothing treatment cylinder is a washing and drying cylinder, and the clothing treatment cylinder is a sleeve structure, that is, the clothing treatment cylinder has an outer cylinder and an inner cylinder (also known as a drum) rotatably arranged in the outer cylinder. The water box 1 of the atomization device can be arranged on the outer cylinder, the door device and/or the connecting member. At this time, the connecting member is a window gasket. A front end of the window gasket is connected with the clothing throw-in port, and a rear end of the window gasket is connected with the outer cylinder. The window gasket is used to ensure sealing between the outer cylinder and the clothing throw-in port. In the present disclosure, the clothing treatment agent can be water, or detergent, softener, softening agent, fragrance enhancer, or another clothing treatment solvent, or a mixture of the aforementioned water and solvents. The atomized gas is droplets with a large number of small particles formed. Since it is not easy to observe each small droplet with the naked eye, a gas like structure is formed. The atomization device can disperse the clothing treatment agent and dispense it onto the clothing in the clothing treatment cylinder.

Hitherto, the technical solutions of the present disclosure have been described in connection with the preferred embodiments shown in the accompanying drawings, but it is easily understood by those skilled in the art that the scope of protection of the present disclosure is obviously not limited to these specific embodiments. Without departing from the principles of the present disclosure, those skilled in the art can make equivalent changes or replacements to relevant technical features, and all the technical solutions after these changes or replacements will fall within the scope of protection of the present disclosure.

1-68. (canceled)

69. A clothing treatment apparatus, comprising: a cabinet, a clothing treatment cylinder, and a door device; wherein the clothing treatment cylinder is arranged in the cabinet, and a clothing throw-in port is formed on the cabinet; the door device is configured to open and close the clothing throw-in port, and the clothing throw-in port is connected with the clothing treatment cylinder through a connecting member; and
an atomization device accommodating a clothing treatment agent; the atomization device is arranged on the clothing treatment cylinder, the door device and/or the connecting member, and the atomization device has at least one outlet arranged toward an interior of the clothing treatment cylinder so that the atomization device can spray atomized gas into the clothing treatment cylinder.

70. The clothing treatment apparatus according to claim 69, wherein the atomization device comprises a water box and an atomization sheet; the water box is arranged on the clothing treatment cylinder, the door device and/or the connecting member, the outlet is formed on the water box, and a water containing chamber is formed in the water box to accommodate the clothing treatment agent; the number of the outlet is one and the outlet is communicated with the water containing chamber, and the atomization sheet is arranged on the outlet.

71. The clothing treatment apparatus according to claim 70, wherein a first sealing member and a sealing pressure ring are arranged on the outlet; the atomization sheet is accommodated in the first sealing member, and the sealing pressure ring is pressed against a side of the first sealing member that is close to the interior of the clothing treatment cylinder.

72. The clothing treatment apparatus according to claim 70, wherein a side of the water box that faces the interior of the clothing treatment cylinder is snap-fitted with a decorative shell, and an opening communicated with the outlet is formed on the decorative shell.

73. The clothing treatment apparatus according to claim 70, wherein the water box is also formed with an electrical chamber; the electrical chamber is isolated from the water containing chamber, and the electrical chamber can accommodate a wire harness connected with the atomization sheet.

74. The clothing treatment apparatus according to claim 73, wherein the atomization device further comprises a wireless charging assembly for supplying power to the atomization sheet; the wireless charging assembly is connected with the water box, and a part of the wireless charging assembly is located inside the electrical chamber.

75. The clothing treatment apparatus according to claim 74, wherein the wireless charging assembly comprises a fixed member, an induction coil, an inductive element, a first circuit board, and a second circuit board; the fixed member is arranged on the clothing treatment cylinder, the door device and/or the connecting member, and the fixed member is connected with the water box; the induction coil and the inductive element are both arranged on the fixed member, and the induction coil is sleeved on an outer side of the inductive element; the first circuit board is connected with the induction coil, and the second circuit board is connected with the inductive element.

76. The clothing treatment apparatus according to claim 75, wherein the fixed member comprises a fixed inner plate and a fixed outer plate; the fixed inner plate is connected with the water box, and the fixed outer plate is fixed on the clothing treatment cylinder, the door device and/or the connecting member; the fixed outer plate is formed with a first hollow columnar structure, and the fixed inner plate is formed with a second hollow columnar structure; the second hollow columnar structure is sleeved on the first hollow columnar structure, the induction coil is sleeved on the second hollow columnar structure, and the inductive element is arranged in the first hollow columnar structure; the first circuit board is arranged on the fixed inner plate, and the second circuit board is arranged on the fixed outer plate.

77. The clothing treatment apparatus according to claim 76, wherein an installation port is formed on the water box, an installation rib is formed on an inner wall of the installation port, and an installation groove is formed at an edge of the fixed inner plate;
the installation rib is arranged in the installation groove to fix the fixed inner plate on the water box.

78. The clothing treatment apparatus according to claim 70, wherein the water box comprises a box body and a box cover; the box body is arranged on the clothing treatment cylinder, the door device and/or the connecting member, and the outlet is formed on the box body; and
an abutment member and a snap-fit member are arranged between the box cover and the box body; and when the box cover and the box body are installed, the box cover is first abutted onto the box body through the abutment member, and then the box cover and the box body are snap-fitted and fixed through the snap-fit member.

79. The clothing treatment apparatus according to claim 78, wherein a second sealing member is arranged between the box body and the box cover, and a through opening is formed on the second sealing member; the snap-fit member comprises a first snap-fit element arranged on the box cover and a second snap-fit element arranged on the box body, and the first snap-fit element passes through the through opening and is snap-fitted and fixed with the second snap-fit element.

80. The clothing treatment apparatus according to claim 78, wherein the water box further comprises a feeding cover, and a feeding port is formed on the box cover; a first spiral groove is formed on the feeding cover, a second spiral groove is formed on the feeding port, and the feeding cover is screw-connected with the feeding port through the first spiral groove and the second spiral groove.

81. The clothing treatment apparatus according to claim 80, wherein a handle ring is rotatably connected with an outer surface of the feeding cover, and the handle ring can rotate in a non-pulling state and be accommodated in the feeding port.

82. The clothing treatment apparatus according to claim 80, wherein a third sealing member is arranged between the feeding cover and the feeding port.

83. The clothing treatment apparatus according to claim 69, wherein the atomization device comprises a water box and a plurality of atomization sheets; the water box is arranged on the clothing treatment cylinder, the door device and/or the connecting member, and the water box is formed with a plurality of water containing chambers for accommodating the same or different clothing treatment agents; the number of the outlet is multiple, and each of the outlets is formed on the water box; the water containing chambers, the outlets and the atomization sheets correspond to each other in a one-to-one correspondence; the outlets are communicated with the corresponding water containing chambers, and the atomization sheets are arranged on the corresponding outlets.

84. The clothing treatment apparatus according to claim 69, wherein the clothing treatment apparatus is a clothing dryer, and the connecting member is a front support structure of the clothing dryer.

85. The clothing treatment apparatus according to claim 69, wherein the clothing treatment apparatus is a washing-drying integrated machine, and the connecting member is a window gasket of the washing-drying integrated machine.
